(19) United States
(12) Patent Application Publication
(10) Pub. No.: US 2023/0412807 A1
(43) Pub. Date: Dec. 21, 2023

(54) BIT ALLOCATION FOR NEURAL NETWORK FEATURE CHANNEL COMPRESSION

(71) Applicant: HUAWEI TECHNOLOGIES CO., LTD., Shenzhen (CN)

(72) Inventors: Alexander Alexandrovich Karabutov, Munich (DE); Saeed Ranjbar Alvar, Burnaby (CA); Ivan Bajic, Burnaby (CA); Hyomin Choi, Burnaby (CA); Robert A. Cohen, Burnaby (CA); Sergey Yurievich Ikonin, Moscow (RU); Timofey Mikhailovich Solovyev, Munich (DE); Elena Alexandrovna Alshina, Munich (DE)

(21) Appl. No.: 18/459,110

(22) Filed: Aug. 31, 2023

Related U.S. Application Data
(63) Continuation of application No. PCT/RU2021/000096, filed on Mar. 9, 2021.

(51) Int. Cl. H04N 19/124; H04N 19/37; G06N 3/042

(52) U.S. Cl. CPC H04N 19/124; H04N 19/37; G06N 3/042

(57) ABSTRACT

Methods and apparatuses for compression of feature tensors of a neural network are provided. One or more encoding parameters for encoding the channels of a feature tensor are selected according to the importance of the channels. This enables unequal bit allocation according to the importance. Furthermore, the deployed neural network may be trained or fine-tuned considering the effect of encoding noise applied to the intermediate feature tensors. According to the present disclosure, the encoding and modified training methods are advantageous at least for employment in a collaborative intelligence framework.

### CROSS-REFERENCE TO RELATED APPLICATIONS

This application is a continuation of International Application No. PCT/RU2021/000096, filed on Mar. 9, 2021, the disclosure of which is hereby incorporated by reference in its entirety.

### TECHNICAL FIELD

Embodiments of the present disclosure generally relate to the field of compression. In particular, some embodiments relate to compression for use in the framework of artificial intelligence and especially neural networks.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video pictures. The compressed data is then received at the destination by a video decompression device that decodes the video data. With limited network resources and ever increasing demands of higher video quality, improved compression and decompression techniques that improve compression ratio with little to no sacrifice in picture quality are desirable.

The encoding and decoding of the video may be performed by standard video encoders and decoders, compatible with H.264/AVC, HEVC (H.265), VVC (H.266) or other video coding technologies, for example.

In recent years, deep learning (DL) is gaining popularity in the fields of picture and video encoding and decoding. In particular, collaborative intelligence has been one of several new paradigms for efficient deployment of deep neural networks (DNN) across the mobile-cloud infrastructure. By dividing the network, e.g. between a (mobile) device and the cloud, it is possible to distribute the computational workload such that the overall energy and/or latency of the system is minimized. In general, distributing the computational workload allows resource-limited devices to be used in a neural network deployment. A neural network (NN) usually comprises two or more layers. A feature tensor is an output of a layer. In a neural network that is split between devices (e.g. between a device and a cloud), a feature tensor at the output of the place of splitting (e.g. a first device) is compressed and transmitted to the remaining layers of the neural network (e.g. to a second device).

Transmission resources are typically limited so that compression of the transferred data may be desirable. In general, compression may be lossless (e.g. entropy coding) or lossy (e.g. applying quantization). The lossy compression typically provides a higher compression ratio. However, it is in general irreversible, i.e. some information may be irrecoverably lost. On the other hand, the quality of compression can have a significant impact on the accuracy of the actual task solved by the neural network. Multi-task neural networks are networks that are developed to perform multiple tasks (e.g., image classification, object detection, segmentation, and so on). In case of multi-task neural networks, the lossy compression affects the accuracy of multiple tasks. Moreover, a method of training neural networks considering the effect of lossy compression of feature tensors may be of a considerable importance given that feature tensors are generally compressed in a lossy manner to achieve higher compression ratios.

### SUMMARY

Some embodiments relate to methods and apparatuses for compressing data used in a neural network. Such data may include but is not limited to features (e.g. feature tensors).

The invention is defined by the scope of independent claims. Some of the advantageous embodiments are provided in the dependent claims.

In particular, some embodiments of the present disclosure relate to selection of quantization parameters for encoding the channels in a feature tensor based on the channel importance. This approach may provide for better performance of single-task and multi-task neural networks, e.g. in terms of accuracy.

According to an embodiment, an apparatus is provided for encoding two or more feature channels of a neural network into a bitstream, the apparatus comprising: a processing circuitry configured to for each of the two or more feature channels: determine importance of the two or more feature channels; select one or more encoding parameters for the feature channel according to the determined importance; and encode the feature channel into the bitstream according to the selected one or more encoding parameters, wherein the determined importance differs for at least two among the two or more feature channels. Accordingly, the compression efficiency of the neural network is improved by encoding one or more feature channels in accordance with their importance.

In one implementation example, the processing circuitry is configured to generate the two or more feature channels, wherein the generating includes processing an input picture with one or more layers of the neural network. Accordingly, the encoding apparatus may generate feature channels on its own so that an integrated encoding device with the neural network and the feature encoder may be provided. However, the present disclosure is not limited thereby, as the feature channels may alternatively be, e.g. pre-generated and stored or available from a cloud.

For example, the one or more encoding parameters include any of coding unit size, prediction unit size, bit depth, and quantization step. Accordingly, the encoding of the two or more feature channels may be applicable to any kind of parameters. This also enables further optimizations by selecting among a variety of encoding parameters most suitable for the particular application and/or content. Hence, the compression efficiency may be improved.

According to an exemplary implementation, the two or more feature channels are for a single-task of the neural network, and the processing circuitry is configured to determine the importance for the single task being accuracy of the neural network. Therefore, the compression may be optimized so as to ensure a high quality of encoded feature channels. Moreover, the encoding may be tuned and optimized specifically and more accurately for a single task.

In a further implementation, the determining of the importance of the two or more feature channels is based on an importance metric. Hence, the importance of the feature channels may be reliably quantified according to a desired measure. For example, the importance metric includes a sum of absolute values of the feature channel. Accordingly, the importance of the feature channels is calculated in a manner with low complexity.

According to an implementation example, the one or more encoding parameters include a quantization step size (or Quantization Parameter (QP)); and the higher the importance of the feature channel, the lower the QP. Hence, important feature channels are resolved and encoded with high accuracy, while the less important channel may be encoded with less bits. Further, the compression efficiency is tunable by adapting the quantization steps size to the importance of the content.

In another implementation example, the one or more encoding parameters include a bit depth; and the higher the importance of the feature channel, the larger the bit depth. Hence, the unequal bit allocation for encoding feature channels is based on channel importance, improving the compression efficiency.

According to an implementation, the two or more feature channels are for multiple tasks of the neural network, and the processing circuitry is configured to determine the importance of the feature channel for each of the multiple tasks. Hence, the importance of the feature channels is task specific, which enables a more accurate selection of the encoding parameters, because different tasks may have different channel importance. This improves the compression efficiency.

For example, the determining of the importance includes estimating mutual information for each pair of the feature channels and the multiple tasks. Accordingly, the channel importance accounts for independencies or dependencies between channels and multiple tasks, which improves the compression efficiency of multiple tasks neural networks. Moreover, the selection of encoding parameters may be further optimized for one or more specific tasks or all of the multiple tasks.

In a further implementation example, the importance includes a task importance of a task among the multiple tasks. For example, the task importance includes priority of the task and/or a frequency of usage of the task. Hence, a particular weight may be put onto one or more tasks and adapted to a specific application (e.g. surveillance).

According to an implementation, the processing circuitry is configured to select as the one or more encoding parameters quantization step or the bit depth; the higher the importance of the feature channel, the smaller the quantization step; and the importance is given as a function of the mutual information and the task importance. Therefore, the encoding of the two or more feature channels may be optimized for multiple tasks while accounting both for task dependencies (via mutual information) and preference to one or more specific tasks (via the task importance). As a result, the compression efficiency is improved.

In one example implementation, the neural network is trained for one or more of picture segmentation, object recognition, object classification, disparity estimation, depth map estimation, face detection, face recognition, pose estimation, object tracking, action recognition, event detection, prediction, and picture reconstruction. Accordingly, the encoding of two or more feature channels may be performed for a neural network trained for a variety of different tasks (i.e. as single task or multiple tasks). Thus, the neural network may be used for varying applications in which either a single task is executed or simultaneous multiple tasks. Hence, the neural network may be adapted and optimized to a wide range of applications.

According to an implementation example, the processing circuitry is configured to, for each feature channel: determine whether the importance of the feature channel exceeds a predetermined threshold; if the importance of the feature channel exceeds the predetermined threshold, selecting for the feature channel the at least one encoding parameter leading to a first quality; if the importance of the feature channel does not exceed the predetermined threshold, selecting for the feature channel the at least one encoding parameter leading to a second quality lower than the first quality. Thus, the one or more encoding parameters are easily selected according to a predetermined threshold, ensuring a higher quality of encoding for more important channels.

According to an embodiment, an apparatus is provided for decoding two or more feature channels of a neural network from a bitstream, the apparatus comprising: a processing circuitry configured to, for each feature channel: determine one or more encoding parameters based on the bitstream; and decode from the bitstream the feature channel based on the determined one or more encoding parameters; wherein the encoding parameters differs for at least two among the two or more feature channels. Hence, the two or more feature channels are decoded from the bitstream using encoding parameters optimized for the respective feature channels.

According to an embodiment, an apparatus is provided for training a neural network for encoding two or more feature channels of the neural network, the apparatus comprising: a processing circuitry configured to: input into the neural network training data; generate two or more feature channels by processing the training data with one or more layers of the neural network; for each feature channel among the two or more feature channels determine importance of the feature channel and add noise to the feature channel according to the determined importance; generate output data by processing the feature channels with the added noise with the one or more layers of the neural network; and update one or more parameters of the neural network in accordance with the training data and the output data, wherein the determined importance differs for at least two among the two or more feature channels. For example, the noise includes pre-quantization noise and/or lossy compression noise. As a result, the accuracy of compression may be improved by noise-augmented training. Hence, the noise-trained neural network is able to compensate for information loss due to quantization and lossy compression, making the network parameters (weights) more resilient to this type of information loss.

In one exemplary implementation, the processing of the two or more feature channels includes: determining a task-specific error based on the noisy output data; and determining a total error based on the determined task-specific errors. For example, the total error is a weighted sum of the task specific errors based on weights assigned to each of multiple tasks. Accordingly, the neural network is trained in a task-specific manner while accounting for multiple tasks. This improves the resiliency of neural network parameters for multiple tasks.

In another implementation, the weights are one of being equal, unequal, or trainable. Hence, the total error may be adapted in a flexible manner by using appropriate weights. This improves the fine tuning of the noise-based training, leading to an improved resiliency of the neural network.

According to a further implementation, the updating of the one or more parameters is based on the total error. Thus, the updating of the neural network parameters is performed in a simple manner, while still accounting for errors specific to multiple tasks. This reduces the complexity of the training.

According to an embodiment, a method is provided for encoding two or more feature channels of a neural network into a bitstream, the method comprising steps of, for each of the two or more feature channels: determining importance of the two or more feature channels; selecting one or more encoding parameters for the feature channel according to the determined importance; and encoding the feature channel into the bitstream according to the selected one or more encoding parameters, wherein the determined importance differs for at least two among the two or more feature channels.

According to an embodiment, a method is provided for decoding two or more feature channels of a neural network from a bitstream, the method comprising steps of, for each feature channel: determining one or more encoding parameters based on the bitstream; and decoding from the bitstream the feature channel based on the determined one or more encoding parameters, wherein the encoding parameters differs for at least two among the two or more feature channels.

According to an embodiment, a method is provided for training a neural network for encoding two or more feature channels of the neural network, the method comprising steps of: inputting into the neural network training data; generating two or more feature channels by processing the training data with one or more layers of the neural network; for each feature channel among the two or more feature channels determining importance of the feature channel and adding noise to the feature channel according to the determined importance; generating output data by processing the feature channels with the added noise with the one or more layers of the neural network; and updating one or more parameters of the neural network in accordance with the training data and the output data, wherein the determined importance differs for at least two among the two or more feature channels.

The methods provide similar advantages as the apparatuses performing the corresponding steps and described above.

According to an embodiment, provided is a computer-readable non-transitory medium storing a program, including instructions which when executed on one or more processors cause the one or more processors to perform the method according to any of the above embodiments.

According to an embodiment, an apparatus is provided for encoding two or more feature channels of a neural network into a bitstream, the apparatus comprising: one or more processors; and a non-transitory computer-readable storage medium coupled to the one or more processors and storing programming for execution by the one or more processors, wherein the programming, when executed by the one or more processors, configures the encoder to carry out the encoding method according to the above embodiment.

According to an embodiment, an apparatus is provided for decoding two or more feature channels of a neural network from a bitstream, the apparatus comprising: one or more processors; and a non-transitory computer-readable storage medium coupled to the one or more processors and storing programming for execution by the one or more processors, wherein the programming, when executed by the one or more processors, configures the decoder to carry out the decoding method according to the above embodiment.

According to an embodiment, an apparatus for training a neural network for encoding two or more feature channels of the neural network, the apparatus comprising: one or more processors; and a non-transitory computer-readable storage medium coupled to the one or more processors and storing programming for execution by the one or more processors, wherein the programming, when executed by the one or more processors, configures the encoder to carry out the training method according to the above embodiment.

According to an embodiment, provided is a computer program comprising a program code for performing the method when executed on a computer according to any one of the above methods.

The embodiments and examples mentioned above can be implemented in hardware (HW) and/or software (SW) or in any combination thereof. Moreover, HW-based implementations may be combined with SW-based implementations.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the present disclosure are described in more detail with reference to the attached figures and drawings, in which

FIG. 1 is a block diagram illustrating a feature encoding system and a feature decoding system for a single-task neural network.

FIG. 2 is a block diagram of an exemplary single-task network, showing its front-end and back-end.

FIG. 3 is an illustration of an input image and the resulting feature tensor produced by the network front-end.

FIG. 4 is a performance graph showing accuracy vs. bits for a single-task network.

FIG. 5 is a performance graph showing accuracy vs. bits for a pre-trained single-task network and a fine-tuned single-task network.

FIG. 6 is a block diagram illustrating a feature encoding system and a feature decoding system for a multi-task neural network.

FIG. 7 is an embodiment of a feature encoding system and a feature decoding system for a multi-task neural network.

FIG. 8 is a block diagram of an exemplary multi-task network, showing its front-end and multiple back-ends.

FIG. 9 is a performance graph showing the accuracy of one task vs. percentage of feature channels pruned in a multi-task network.

FIG. 10 is a performance graph showing the accuracy of one task vs. percentage of feature channels pruned in a multi-task network.

FIG. 11 is a performance graph showing the accuracy of one task vs. percentage of feature channels pruned in a multi-task network.

FIG. 12 is an illustration of assigning two QP values to feature tensor channels in the case of a single-task neural network.

FIG. 13 is an illustration of assigning two QP values to feature tensor channels in the case of a multi-task neural network.

FIG. 14 is an illustration of feature channel encoding and decoding of a single-task neural network, based on computed channel importance and using a quantization parameter according to the channel importance.

FIG. 15 is an illustration of feature channel encoding and decoding of a multi-task neural network, based on computed task-specific channel importance and using a quantization parameter according to the task-specific channel importance.

FIG. 16 is a block diagram illustrating an exemplary encoding apparatus for encoding feature channels according to an embodiment.

FIG. 17 is a block diagram illustrating an exemplary decoding apparatus for decoding feature channels according to an embodiment.

FIG. 18 is a flowchart illustrating an exemplary encoding method for encoding feature channels according to an embodiment.

FIG. 19 is a flowchart illustrating an exemplary decoding method for decoding feature channels according to an embodiment.

FIG. 20 is a block diagram illustrating an exemplary training apparatus for training a neural network for encoding feature channels according to an embodiment.

FIG. 21 is a flowchart illustrating an exemplary training method for training a neural network for encoding feature channels according to an embodiment.

FIG. 22 is a block diagram showing an example of a video encoder configured to implement embodiments of the present disclosure.

FIG. 23 is a block diagram showing an example structure of a video decoder configured to implement embodiments of the present disclosure.

FIG. 24 is a block diagram showing an example of a video coding system configured to implement embodiments of the present disclosure.

FIG. 25 is a block diagram showing another example of a video coding system configured to implement embodiments of the present disclosure.

FIG. 26 is a block diagram illustrating an example of an encoding apparatus or a decoding apparatus.

FIG. 27 is a block diagram illustrating another example of an encoding apparatus or a decoding apparatus.

### DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Some embodiments aim at providing a data compression method using the importance of the feature channels in the data for the overall accuracy of the (possibly already-trained) neural network. For example, the data may include feature tensors, or other data used in neural networks such as weights or other parameters. In some exemplary implementations, compression is provided which may be capable of compressing a feature tensor while maintaining the overall accuracy of the (possibly already-trained) neural network. Some embodiments may also handle feature tensor compression in multi-task neural networks. According to a collaborative intelligence paradigm, mobile or edge device may have a feedback from the cloud, if it is needed. However, it is noted that the present disclosure is not limited to the framework of collaborative networks including cloud. It may be employed in any distributed neural network system. Moreover, it may be employed for storing feature tensors also in neural networks, which are not necessarily distributed.

In the following, an overview over some of the used technical terms is provided.

A neural network has typically at least one layer. For picture processing, there are typically networks which have more than one layers including one input layer and at least one output layer. A neural network that is trained to perform one task such as image/text classification, object detection, semantic/instance segmentation, image/video reconstruction, time-series predictions etc. is called a single-task neural network. A neural network that is trained to perform multiple tasks (either sequentially or simultaneously) is referred to as a multi-task neural network. In one layer of a neural network, there may be one or more neural network nodes, each of which computes an activation function based on one or more of inputs to the activation function. Typically, the activation function is non-linear. A deep neural network (DNN) is a neural network, which has one or more hidden layers.

A feature tensor is an output of a layer (input layer, output layer, or hidden layer) of neural network. A feature tensor may include one or more features or feature channels. A feature tensor value is a value of an element of a feature tensor, wherein a feature tensor can comprise multiple channels. Each channel may include a feature or several features. Activations are feature tensor values output by activation functions of a neural network.

Collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device and one or more layers may be executed in another device. However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature tensor) is passed to a cloud. A cloud is a collection of processing or computing systems that are located outside the device, which is operating the part of the neural network.

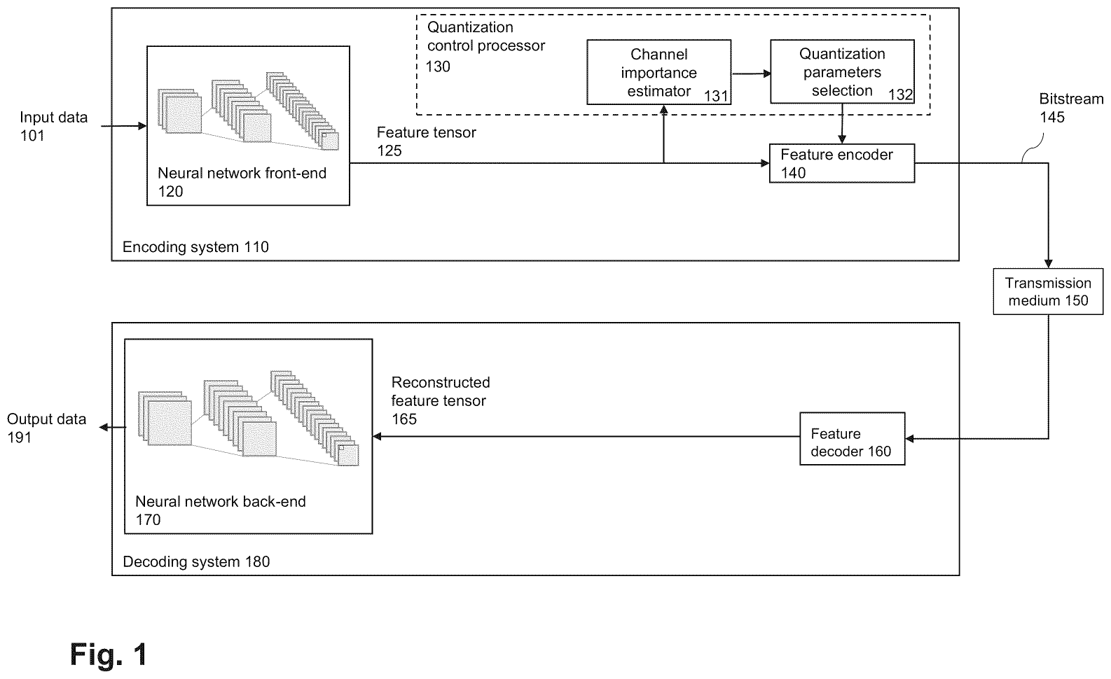

FIG. 1 illustrates a single-task collaborative intelligence system comprising (at least) two entities (systems): an encoding system 110 and a decoding system 180. In this example, the encoding system 110 may be implemented on an edge device or a mobile user device. In general, edge or mobile devices have less computation power than the computing servers or the cloud, where the decoding system 180 is implemented. In order to perform more computationally complex tasks, the encoding system 110 performs only a part of the task and transmits the intermediate result to the decoding system 180 over a transmission medium 150.

The encoding system 110 may include a first number of neural network layers, which is referred to as the neural network front-end 120. The neural network front-end 120 processes input data 101 to generate a feature tensor 125. The feature tensor 125 is then encoded with a feature encoder 140 to produce the bitstream 145.

The neural network may be a DNN. Layers in a DNN may include operations such as convolutions, batch normalization operations, pooling, and activation functions. The output of a layer is a feature tensor. If the front-end of a DNN 120 is implemented for example on a mobile or edge device, it would be useful to compress the feature tensor output by the network front-end 120 for transmission 150 to the decoding system 180 that is performing the remaining layers (neural network back-end) 170 of the DNN.

A feature tensor 125 generally consists of multiple channels where each channel is obtained by a function or a process such as convolution in a neural network. When a reconstructed feature tensor 165, which includes the reconstructed channels of the feature tensor 125 obtained by the neural network front-end 120, is fed to the neural network back-end 170, the processes in the back-end 170 apply different kernels, functions, or activations to the channels in the reconstructed feature tensor 165. Feature tensor channels may carry unequal information regarding the output.

For the purposes of this disclosure, feature channel “importance” is a quantitative measure of the effect of a channel on the accuracy of a DNN task. In general, different channels will have different importance for the accuracy of the task that the DNN is trained for. Therefore, the compression may be optimized, e.g. to improve quality of encoded feature channels for the same rate or vice versa.

In general, the encoding may be tuned and optimized for a single task or for multiple tasks. For example, a neural network such as neural network 120 in FIG. 1 may be trained for one or more tasks including picture segmentation, object recognition, object classification, disparity estimation, depth map estimation, face detection, face recognition, pose estimation, object tracking, action recognition, event detection, prediction, and picture reconstruction.

In other words, the present disclosure is applicable for a neural network trained for a variety of different tasks (i.e. as single task or multiple tasks). These tasks are not limited to those listed, but rather may include any other task suitable for processing employing a (deep) neural network framework. Each of these tasks may have different demands on the accuracy of the task being executed. For example, the accuracy demand for face detection may be higher than the accuracy needed for mere picture segmentation.

The role of quantization control processor 130 is to estimate the feature channel importance and adjust its compression accordingly. In particular, channel importance estimator 131 estimates the feature channel importance and the quantization parameter selection block 132 adjusts the quantization parameters accordingly to improve the accuracy of the DNN task. The selected quantization parameters are used in the feature encoder 140 to produce the bitstream 145. The feature encoder 140 may include an optional pre-quantization with L (L 1) levels, as well as other processing steps such as prediction, transformation, quantization and entropy coding, as is known in the art. In summary, the encoding system 110 comprises one or more neural network layers (front-end) 120, quantization control processor 130 and feature encoder 140.

Herein, the term bitstream refers to a bitstream which may be used for transmission 150 and/or storing or buffering, or the like. Before the transmission, the bitstream may undergo further packetization including coding and modulation and possibly further transmitter operations, depending on the medium over which the encoded data is transmitted. The compressed bitstream is sent to the cloud or another computing platform, where it is decoded by a decoding system 180.

The decoding system 180 comprises the feature decoder 160 and a neural network back-end 170 for decoding two or more feature channels 165 (i.e. the feature tensor 165) of the neural network 170. The feature decoder takes bitstream 165 as input and determines one or more encoding parameters from bitstream 165 for the feature channels. The feature decoder 160 takes in the bitstream 145 and produces the reconstructed feature tensor 165 (i.e. the two or more feature channels) based on the encoding parameters. The encoding parameters (their value) may be different for at least two among the two or more feature channels. Hence, the two or more feature channels are decoded from the bitstream using encoding parameters, which may be optimized for the respective feature channels. With lossless compression (i.e. in the absence of quantization), the reconstructed feature tensor 165 would be equal to the original feature tensor 125. With lossy compression, the reconstructed feature tensor 165 is only an approximation to the feature tensor 125.

The reconstructed feature tensor 165 is input to the neural network back-end 170, which in turn produces output data 191 according to the purpose of the neural network. The purpose of the neural network (i.e., the task for which it was trained) may be input classification (in which case output data 191 is a classification index), object detection (in which case output data 191 is a set of bounding box coordinates and metadata), instance segmentation (in which case output data 191 is a segmentation map), and so on. Parts or all of the output data 191 can be signaled back to the encoding system 110 or the device where the encoding system 110 is implemented, or to other devices.

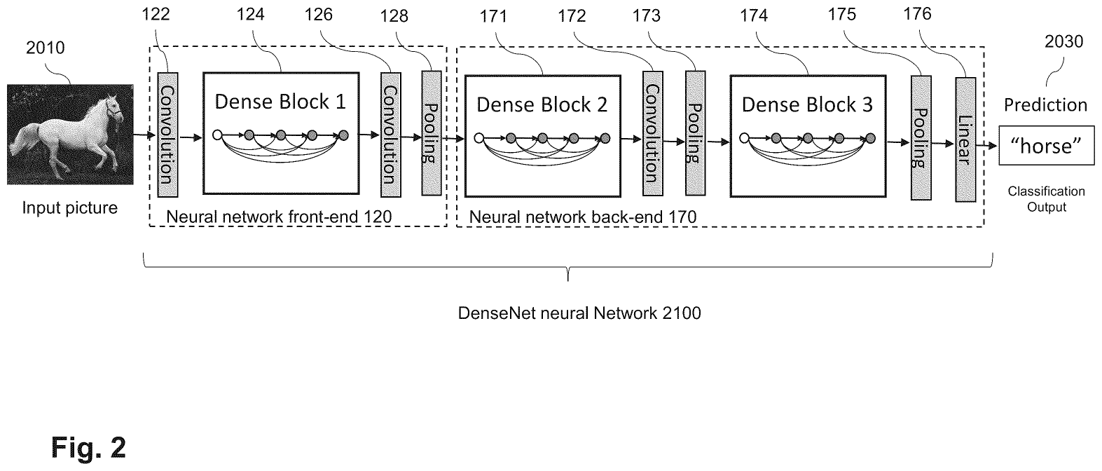

An example of a neural network is shown in FIG. 2, in which case the NN is a DenseNet neural network 2100. Network 2100 includes a front-end neural network 120 and a back-end neural network 170, each of which has multiple NN layers including layers for performing functions of convolution (layers 122, 126, 172) and pooling (layers 128, 173, 175) along with dense blocks 124, 171, 174. In the example shown in FIG. 2, the input layer of the NN is a convolution layer 122, while the output layer is a linear layer 176. In the case of FIG. 2, the NN is trained for image classification in that it takes as input to the NN input picture 2010 and provides as output a classification result 2030 of a “horse” being contained in input picture 2010.

One embodiment provides for use of a feature channel importance to reduce the bitrate of the encoded feature tensor while preserving DNN accuracy. The feature tensor of a neural network may have two or more feature channels. In one embodiment, an importance is determined for each of the two or more feature channels. For example, the channel importance may be estimated by channel importance estimation 131, which enables generation of quantization parameters 132. The quantization parameters 132 are only one example of encoding parameters. In general, encoding parameters may be selected based on the importance. The encoding parameters may include any of any of coding unit size, prediction unit size, bit depth, prediction mode, quantization step, or the like. It may be desirable to employ encoding parameters, different setting of which results in different rate (amount of bits) after encoding. Accordingly, the encoding of the two or more feature channels may be optimized by controlling one or more of encoding parameters. Hence, the compression efficiency may be improved.

The encoding parameters are provided to the feature encoder 140 to enable encoding of the feature tensor in a manner that allocates more bits (better quality) to feature channels that are more important for DNN accuracy, while fewer bits (lower quality) are provided to other, less-important channels. In this case, one of the selected encoding parameters refers to bit depth, where a larger bit depth (i.e. a larger number of bits) is used for more important feature channels. In short, the higher the importance of the feature channel, the larger the bit depth. Hence, the unequal bit allocation for encoding feature channels is based on channel importance, allocating more bits to important feature channels.

In said embodiment, a feature tensor 125 is obtained from the neural network front-end 120. For example, two or more feature channels may be generated by processing an input picture 101 with one or more layers (e.g. layers 122, 124, 126, 128 in FIG. 2) of the neural network, i.e. neural network front-end 120. The input picture may be a still picture or video picture. The input may include one or more input pictures. The processing by the NN layers may include operations of convolution, pruning, pooling, batch normalization operations, pooling, connection skipping, and/or activation functions or any other processing. The importance of each channel in the feature tensor is estimated by the channel importance estimator 131. Let the dimension of the feature tensor be H×W×N, where H is height, W is width, and N is the number of channels. Also, let the feature tensor be represented as F={C₁, C₂, . . . , C_{N}}, where Cᵢ is the i-th channel with dimension H×W.

The importance of a channel may be estimated in various ways, including, but not limited to: 1) sensitivity of a performance metric (e.g., DNN accuracy) to quantization noise in that channel, 2) energy of the channel, 3) norm of the channel, 4) mutual information between the channel and the DNN output. Channel importance may be input-dependent, also referred to as “dynamic”, in which case it can be signaled in the bitstream 145. Alternatively, the channel importance may be input-independent, also referred to as “static”, in which case it does not need to be signaled in the bitstream 145, because it is known to both encoding system 110 and decoding system 180.

In general, the importance of a feature channel may be determined (e.g. by estimating) based on an importance metric, which may be a p-norm with p>=1. Hence, the importance of the feature channels may be quantified accurately by use of a metric. The p-norm is also referred to as [symbol] ₚ norm. When p=1, the p-norm corresponds to a (normalized) sum of absolute values, while p=2 refers to the Euclidian norm (normalized sum of squares). When p=∞, the p-norm refers to the maximum/infinity norm. It is noted that a feature channel is usually represented by a matrix of dimension e.g. H×W which may be vectorized, i.e. converted into an equivalent vector of length H*W (“*” denoting multiplication). In this vectorized representation, the respective p-norm would be a vector norm. One non-limiting example of the process performed by the channel importance estimator is to compute the normalized [symbol] ₁ norm of each vectorized channel and use this as an estimate of channel importance:

$${I}_{i} = \frac{{‖ vec ( {C}_{i} ) ‖}_{1}}{{\sum }_{j = 1}^{N} {‖ vec ( {C}_{j} ) ‖}_{1}}$$

where vec(Cᵢ) denotes channel vectorization (conversion from matrix to vector). The [symbol] ᵢ norm of vector x=(x₁, x₂, . . . , x_{M}) is computed as ∥x∥₁=|x₁|+|x₂|+ . . . +|x_{M}|, corresponding to the sum of the absolute values of the feature channel. Accordingly, the importance of the feature channels are calculated in a simple manner and reduces the complexity of determining the channel importance. The above channel importance (simply referred to as importance) may be defined by Iᵢ=∥vec(Cᵢ)∥₁, i.e. without normalization. Normalizing the importance means that Σᵢ₌₁^{N}Iᵢ=1, with the result that 0≤Iᵢ≤1. Moreover, the estimated channel importance may be different for at least two among the two or more feature channels.

As the above example demonstrates using the sum of the absolute values of the feature channel, the importance metric serves the purpose of quantifying the channel importance. As discussed further below, in case of multiple tasks the so-called mutual information may be more suitable to provide estimates of the channel importance as it accounts for channel dependencies when different tasks are performed. Irrespective of whether a single task or multiple tasks are performed by the neural network, it is determined for each channel whether the respective channel importance (after it is estimated) exceeds a predetermined threshold. Using the above channel estimator Iᵢ as example, the predetermined threshold may be 0.75, in which case feature channels having a larger importance (alternatively larger than and equal to) than 0.75 are more important. The predetermined threshold may include one or more predetermined thresholds, as may be needed for more than two groups of channel importance. Since 0≤Iᵢ≤1, m predetermined thresholds may be needed for m+1 importance groups (i.e. the interval [0;1] is divided into m+1 sub-intervals).

In case the channel importance exceeds said threshold, the selected at least one encoding parameter of the respective channel leads to a first quality. In turn, when the importance does not exceed the predetermined threshold, the selected at least one encoding parameter of the respective channel leads to a second quality being lower than the first quality. Thus, the one or more encoding parameters are easily selected according to a predetermined threshold, ensuring a higher quality of encoding for more important channels.

For example, the first and second quality may refer to a reconstruction quality. In case of a first important channel, the encoding parameter may, for example, be a small quantization step (e.g. QP2), and a larger quantization step (e.g. QP1) for a less important channel. Since QP2 is smaller than QP1, the respective channel with QP2 is encoded more accurately and hence has a higher quality (first quality) than the channel encoded with QP1.

Once the channel importance is estimated for each feature channel, one or more encoding parameters are selected according to the channel importance. For example, quantization parameters selection block 132 shown in FIG. 1 receives the estimated channel importance for each channel and generates appropriate quantization parameters to be used by the feature encoder 140. In one embodiment of the system, a High Efficiency Video Coding (HEVC) encoder and decoder is used for the feature encoding and decoding respectively.

In such an embodiment, the quantization parameter selection block may select HEVC Quantization Parameter (QP) as an encoding parameter for each feature channel, with QP specifying a quantization step size. As one non-limiting example, feature channels may be divided into two groups according to estimated importance: the more important group and the less important group. The more important group of channels may be assigned a smaller QP (1202), resulting in more bits used for (and more accurate reconstruction at the decoder of) channels in this group. In turn, the less important group of channels may be assigned a larger QP (1201), resulting in less bits used for (and less accurate reconstruction at the decoder of) channels in this group. In short, the higher the importance of the feature channel, the lower the QP.

With the one or more encoding parameters being selected in accordance with the channel importance, the feature channel may be encoded into the bitstream with use of the encoding parameters. In the example shown in FIG. 1, feature encoder 140 uses the QP values (encoding parameters) selected by the quantization parameters selection block 132 to control the feature tensor compression. If the encoding of the feature channels is done in a specific order, that order may also be signaled in the bitstream 145.

The following experiment illustrates the benefits of unequal QP selection based on feature channel importance. FIG. 2 shows the architecture of the DenseNet neural network for image classification, as is known in the art. The network comprises a number of processing blocks, known as “dense” blocks, each of which consists of convolutional layers, activation layers, pooling layers, and skip connections. In this example, front-end 120 comprises all layers from the input layer to the pooling layer following dense block 1, while the back-end comprises all layers from the input to dense block two to the output of the network. Feature tensor F at the output of the front-end, with dimensions 32×32×128, is compressed using an encoding system 110, where the feature encoder 140 is based on a HEVC encoder.

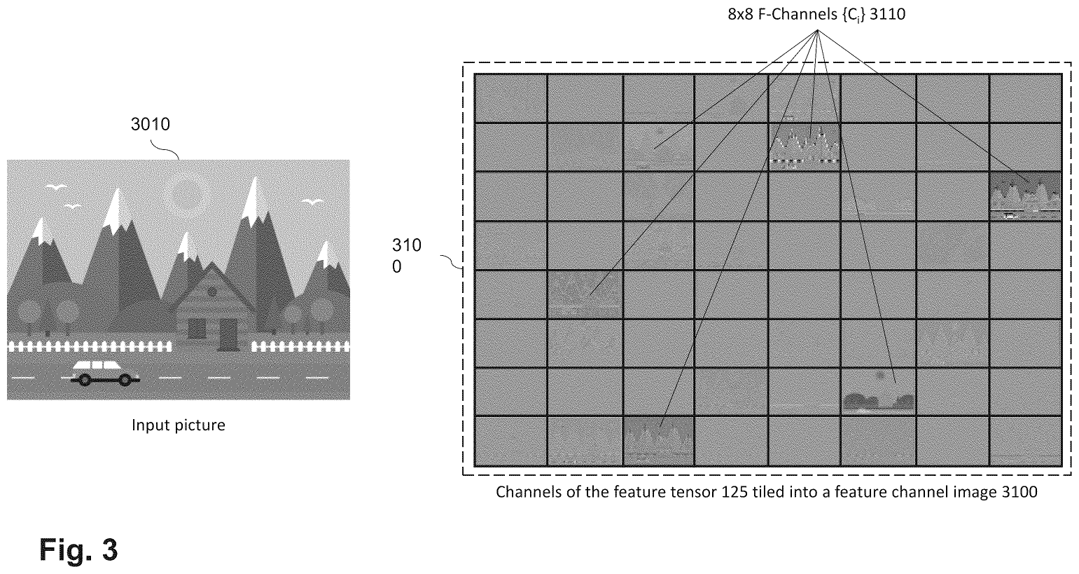

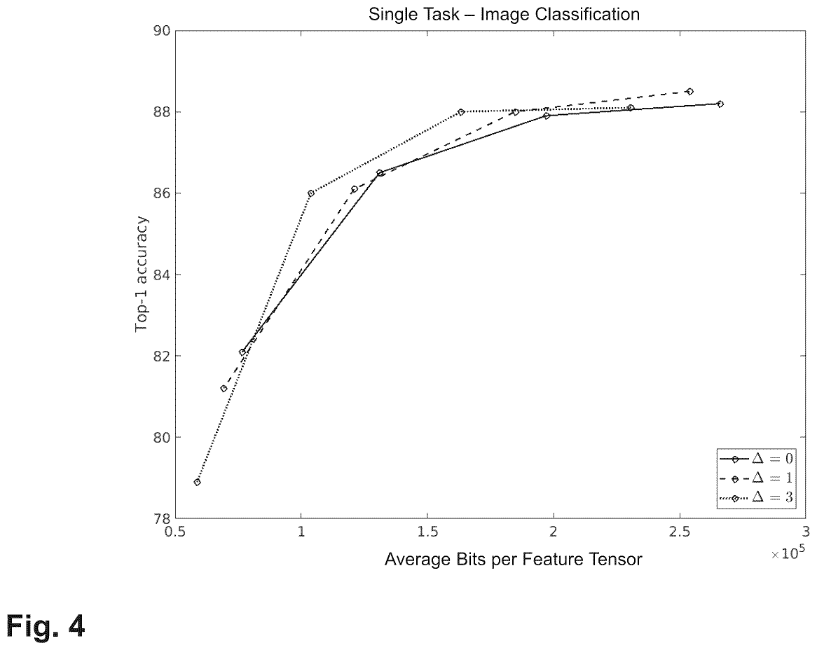

More specifically, channels of a feature tensor are tiled into an image, as shown in FIG. 3, and encoded by the feature encoder 140 employing HEVC coding. Feature channel importance is estimated based on the normalized [symbol] ₁ norm, as discussed above, and the 128 channels are divided into two halves based on such importance: 64 more important channels, and 64 less important channels. For the first group (the more important channels), quantization parameter QP₁ is used, and for the second group (the less important channels), QP₂ is used. Experimental results in terms of average bits per feature tensor vs. Top-1 classification accuracy on the ImageNet validation dataset, as is known in the art, are shown in FIG. 4. One of the curves corresponds to Δ=QP₂−QP₁=0, which means equal QP for both groups of channels. Another curve corresponds to Δ=QP₂−QP₁=1, which means smaller QP (more bits, higher reconstruction quality) for the more important group of channels. And the third curve corresponds to Δ=QP₂−QP₁=3, which means even smaller QP (even more bits, higher reconstruction quality) for the more important group of channels compared to the less important group. As seen in the figure, larger A, which means lower QP (more bits, better reconstruction accuracy) to the more important group of channels improves the Top-1 accuracy at a given bitrate. In this example, for Δ=1, Top-1 accuracy is improved by about 0.16% on average, while for Δ=3, it is improved by 0.63%. Alternatively, for Δ=1, the bitrate required to achieve a given accuracy is reduced by about 2.71% on average, while for Δ=3, it is reduced by 10.96%. This example is given simply as a non-limiting illustration. It should be clear to those skilled in the art that the feature channels may be split into more than two groups, and that different QP values and different Δ values may be used for different groups.

It is noted that HEVC is only an example for an encoder and decoder, which may be used to convey the feature tensor. In general, neural networks which process pictures usually produce channels which have similar features as pictures. For example, they may be defined by width and height and have their elements correlated in these two dimensions. Therefore, any still image or video codec (e.g. set to a profile for encoding individual still images) may be employed. The present disclosure is not limited to encoding single still pictures or isolated frames (pictures) of video. It may be applicable to encode groups of pictures and thus also exploit their temporal correlation. Moreover, the feature channels are not necessarily to be encoded with lossy coding. For example, some kind of lossless transmission may be applied, e.g. for the channels with a higher importance and some kind of lossy compression may be applied e.g. for channel with a lower importance. In such case, the encoding parameters specify the kind of the encoding (e.g. lossy or lossless).

Another embodiment relates to the training (or fine-tuning) of the neural network for improved accuracy. Typically, neural networks are trained without considering compression of its feature tensors. However, lossy compression will result in the loss of information in these feature tensors, which may negatively impact the accuracy of the task the network is performing. In order to compensate for this loss of information, it may be advantageous to train (or fine-tune) the network in a manner that considers information loss due to quantization and lossy compression and makes network parameters (weights) more resilient to this type of information loss. One non-limiting example of such training (or fine-tuning) is described below.

In one embodiment of FIG. 1, the neural network front-end 120 is the part of the DenseNet network 2100 between the input layer 122 and the input to the second dense block 171, as indicated in FIG. 2, and the back-end 170 is the part of the DenseNet network from the input of the second dense block 172 up to the output 2020, as also indicated in FIG. 2. Feature tensor 125 undergoes a L-level (L≥1) pre-quantization followed by lossy HEVC compression in the feature encoder 140. In order to make both the front-end and the back-end more resilient to this type of information loss, the following approach may be used.

The training starts from the DenseNet network pre-trained on the ImageNet dataset, as known in the art. During training, images are presented at the network input 101. The images correspond to training data provided as input to neural network. The training data are processed with one or more layers (e.g. layers 122, 124, 126, 128 in FIG. 2) of neural network 120 so as to generate two or more feature channels by e.g. computing resulting in feature tensor 125 (denoted F). This is followed by determining for each channel an importance, which may be any of the importance suitable for a single task and/or multiple tasks discussed herein. The determined importance may be different for at least two of the two or more feature channels. In order to make the neural network more resilient to information loss, said loss is accounted for as part of the training by adding noise to the feature channels of feature tensor F according to the determined channel importance. The resulting tensor is denoted F. Finally, P′ is passed to the network back-end 170 where the feature channels with the added noise (noisy feature channels) are processed with the one or more layers of the neural network, so as to generate output data. A training error is computed and used to update network parameters via backpropagation, as is known in the art. In other words, one or more parameters of the neural network are updated in accordance with the training data and the output data. As a result, the accuracy of compression is improved by noise-augmented training. Hence, the noise-trained neural network is able to compensate for information loss due to quantization and lossy compression, making the network parameters (weights) more resilient to this type of information loss.

The noise added to feature tensor F has two components in this example, e_{q} and e_{c}:

\tilde{F}=F+e_{q}+e_{c}

The role of e_{q} is to model pre-quantization and the role of e_{c} is to model subsequent lossy compression. For the case of unequal bit allocation (via different QP values), i.e. the encoding parameter corresponds to the quantization step size, e_{c} can model this by introducing different noise energy into different tensor channels, according to their importance. For example, the higher the channel importance, the lower the noise energy that is introduced into the respective channel. In the example described below, e_{q} was modeled as a uniform noise, while e_{c} was modeled as a Gaussian noise with a lower variance for more important channels and a higher variance for less important channels. While uniform noise and Gaussian noise are typically used to model pre-quantization and lossy compression, the noise may include in addition or alternatively other kind of noise so as to model different noise source having a distribution (i.e. noise spectrum) different from uniform and/or Gaussian, such as clipping noise. Moreover, the noise may include correlated noise so as to account for possible cross-talk between different noise sources.

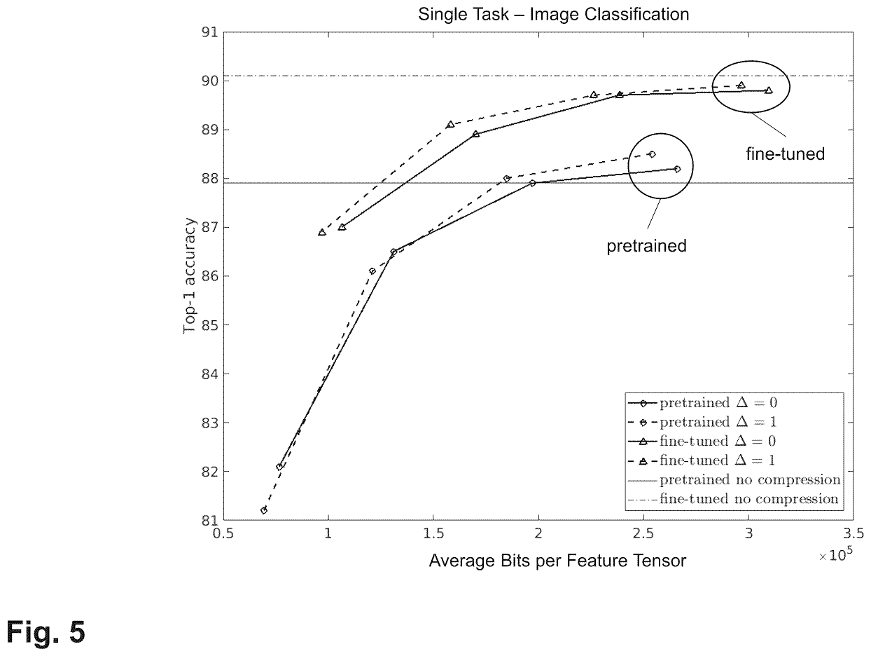

FIG. 5 illustrates how training improves the resiliency of the neural network in case of a single task. FIG. 5 shows the Top-1 accuracy of the pre-trained DenseNet network and the DenseNet network fine-tuned as explained above. For each network, three curves are shown: 1) Top-1 accuracy without feature tensor compression; 2) Top-1 accuracy with feature tensor compression using equal bit allocation (Δ=0); and 3) Top-1 accuracy with feature tensor compression using unequal bit allocation (Δ=1, more bits to more important channels). By comparing the accuracy curves without feature tensor compression (straight lines), it is evident that fine-tuning has improved the accuracy of the DenseNet network by about 2%. This is because the added noise acts as a regularizer and helps improve the network's generalization abilities. Further, it is seen that unequal bit allocation (Δ=1) provides accuracy gain for both the pre-trained and the fine-tuned DenseNet network, but the fine-tuned DenseNet network is more accurate. At the same bitrate, the fine-tuned network with Δ=1 achieves 1.91% accuracy improvement over the pre-trained network with Δ=0. Alternatively, at the same accuracy, the feature tensor 125 of the fine-tuned network with Δ=1 can be compressed to 38.62% fewer bits than the feature tensor of the pre-trained network with Δ=0.

So far, the encoding of the feature channels of the neural network involved determining an importance for each of the feature channels for a single task, which may be one of picture segmentation, object recognition, object classification, disparity estimation, depth map estimation, face detection, face recognition, pose estimation, object tracking, action recognition, event detection, and picture reconstruction.

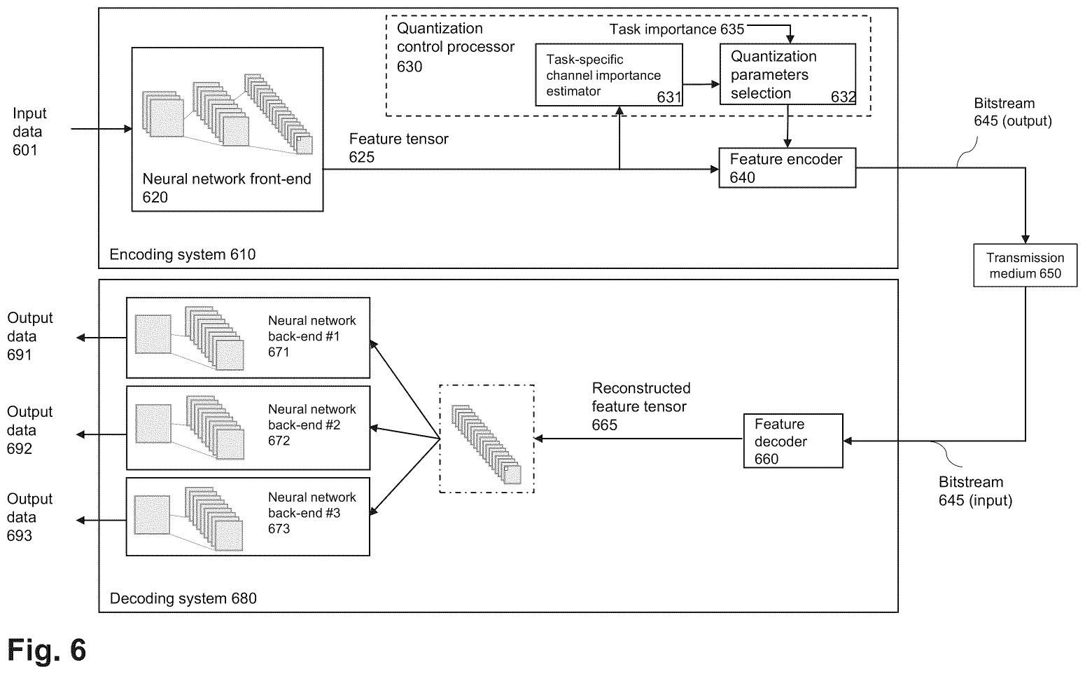

In an alternative embodiment of the present disclosure, the two or more feature channels may be for a multi-task neural network. For example, the neural network may be trained for two tasks such as picture segmentation and object tacking. Accordingly, the importance determined for a channel may be different for the picture segmentation task and the object tracking task. In other words, the channel importance may also depend on the particular task. In this case, the importance of the feature channel is determined (e.g. estimated) for each of the multiple tasks, as exemplified in FIG. 6. Hence, the importance of the feature channels is task specific, which enables a more accurate selection of the encoding parameters. This improves the compression efficiency.

FIG. 6 illustrates such a multi-task collaborative intelligence system comprising (at least) two entities (systems): an encoding system 610 and a decoding system 680. In this example, the encoding system 610 may be implemented on an edge device or a mobile user device. In general, edge or mobile devices have less computation power than the computing servers or the cloud, where the decoding system 680 is implemented. In order to perform more computationally complex tasks, the encoding system 610 performs only a part of the task and transmits the intermediate result to the decoding system 680 over a transmission medium 650.

The encoding system 610 may include a first number of neural network layers, which is referred to as the neural network front-end 620. The neural network front-end 620 processes input data 601 to generate a feature tensor 625. The feature tensor 625 is then encoded with a feature encoder 640 to produce the bitstream 645.

The neural network may be a DNN. Layers in a DNN may include operations such as convolutions, batch normalization operations, pooling, and activation functions. The output of a layer is a feature tensor. If the front-end of a DNN 620 is implemented for example on a mobile or edge device, it would be useful to compress the feature tensor 625 output by the network front-end 620 for transmission 650 to the decoding system 680.

The decoding system 680 comprises the feature decoder 660 and multiple neural network back-ends: 671, 672, 673. The feature decoder 660 takes in the bitstream 645 and produces the reconstructed feature tensor 665. With lossless compression (i.e. in the absence of quantization), the reconstructed feature tensor 665 would be equal to the original feature tensor 625. With lossy compression, the reconstructed feature tensor 665 is only an approximation to the feature tensor 625.

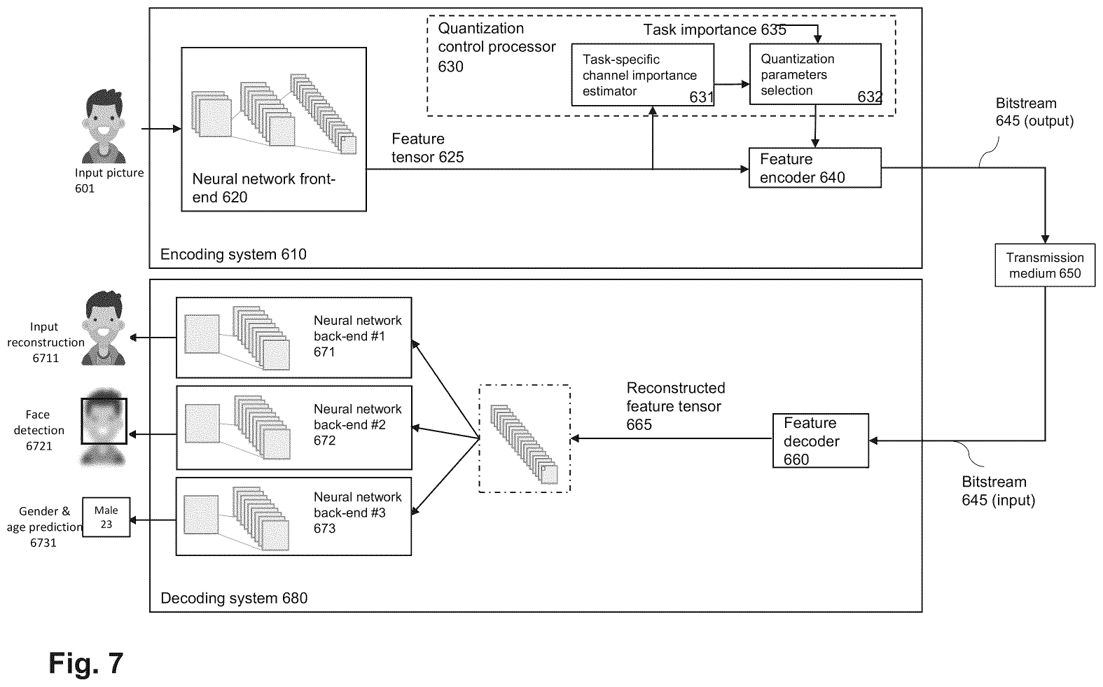

In a multi-task network, there are multiple (more than one) neural network back-ends. Three such back-ends —671, 672, 673—are shown in FIG. 6. Each back-end is fed the same reconstructed feature tensor 665, but each is responsible for a different task and outputs different data. A non-limiting illustration is given in FIG. 7, where the three tasks are: 1) input image reconstruction; 2) face detection; and 3) gender and age prediction. Parts or all of the output data 691, 692, 693 can be signaled back to the encoding system 610 or the device where the encoding system 610 is implemented, or to other devices.

In a multi-task network, various channels of the feature tensor 625 may carry different importance for different tasks. For example, a given feature channel may have high importance for input reconstruction but low importance for gender and age prediction. Hence, what is needed is a measure of importance that depends on both the channel and the specific task, that is, a task-specific channel importance. Task-specific importance of a given feature channel may be estimated in various ways, including, but not limited to: 1) sensitivity of a performance metric (e.g., accuracy) of a given task (output) to the quantization noise in that channel, 2) mutual information between the channel and a specific task (output). In other words, the channel importance is determined by e.g. estimating the mutual information for each pair of the feature channels and the multiple tasks. Accordingly, the channel importance accounts for independencies or dependencies between channels and multiple tasks, which improves the compression efficiency of multiple tasks neural networks. Moreover, the selection of encoding parameters may be further optimized for one or more specific tasks or all of the multiple tasks.

Note that the previously introduced normalized l₁ norm (i.e. the p-norm with p=1) is not task-specific, because it is a function of the channel only, and not the task. A task-specific channel importance may be input-dependent, also referred to as “dynamic”, in which case it can be signaled in the bitstream 645. Such input-dependent scenario is given, for example, in the case of input data 601 being a sequence of two or more input pictures 601 input sequentially to neural network front-end 620. Alternatively, the task-specific channel importance may be input-independent, also referred to as “static”, in which case it does not need to be signaled in the bitstream 645, because it is known to both encoding system 610 and decoding system 680. In this case, input data 601 input to the neural network front-end 620 may not change.

The encoding system 610 includes quantization control processor 630, which comprises task-specific channel importance estimator 631 and the quantization parameters selection block 632. The task-specific channel importance estimator 631 estimates the importance of each channel for each of the tasks. If there are N feature tensor channels and M tasks, the channel importance estimator 631 creates N×M estimates of channel importance, one for each (channel, task) pair. These estimates are fed to the quantization parameters selection block 632 and used to select quantization parameters for feature encoder 640.

In one exemplary embodiment, task-specific channel importance is estimated using mutual information. The concept of mutual information is known in the field of information theory, and is a measure of the amount of information that one random variable carries about another random variable. In other words, the mutual information is a measure for the degree of independencies or dependencies of the two random variables. Let the feature tensor 625 have N channels, F={C₁, C₂, . . . , C_{N}}, where Cᵢ is the i-th channel with dimension H×W. Let the outputs (i.e., output data) of the decoding system 680 be denoted Y₁, Y₂, . . . , Y_{M}, where Yⱼ is the output corresponding to the j-th task. In the said embodiment, the task-specific importance of channel Cᵢ for task j is estimated as MI (Cᵢ; Yⱼ), where M/(X; Y) denotes the mutual information between random variables X and Y.

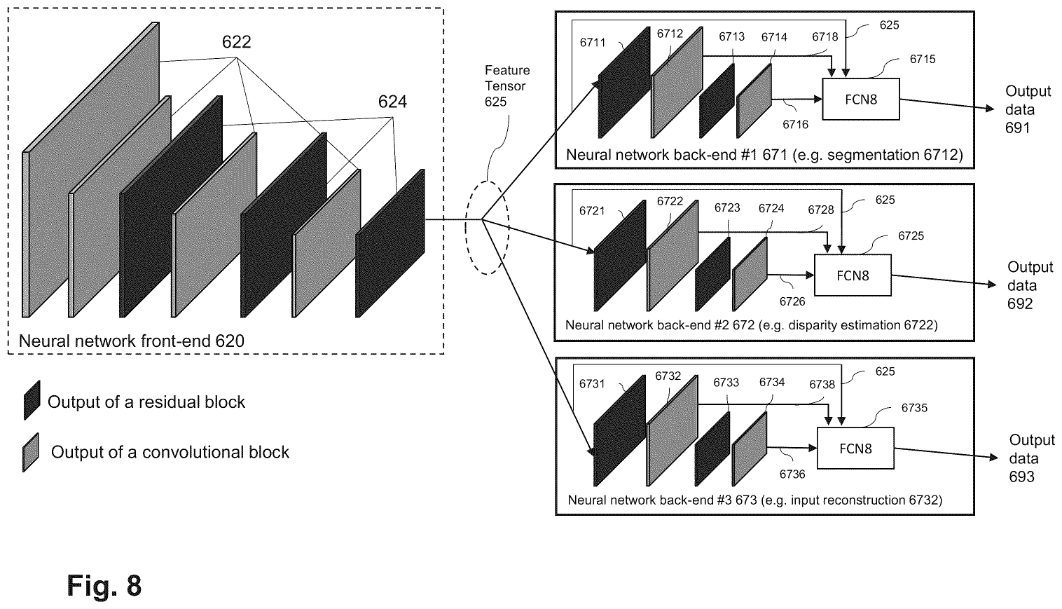

A non-limiting example of a multi-task neural network is shown in FIG. 8. The front-end neural network 620 consists of a series of convolutional blocks 622 and residual blocks 624, which are known in the art. The three back-ends 671, 672, 673 consist of convolutional blocks 6712, 6714, 6722, 6724, 6732, 6734, residual blocks 6711, 6713, 6721, 6723, 6731, 6733, and fully convolutional network FCN8 blocks 6715, 6725, 6735, each of which is known in the art. For example, the FCN architecture is discussed by J. Long et al in “Fully convolutional neural networks for semantic segmentation” (available at https://arxiv.org/abs/1411.4038). The network is trained to perform three tasks: 1) semantic segmentation 6712 (output data 691 is a segmentation map); 2) disparity estimation 6722 (output data 692 is a disparity map); and 3) input reconstruction 6732 (output data 693 is an approximation to the input image 601). The accuracy of the semantic segmentation (task 1) is measured using the mean Intersection over Union (mIoU), as is known in the art. The accuracy of the disparity estimation is measured using the Root Mean Squared Error (RMSE), as is known in the art. The accuracy of the input reconstruction is measured using the Peak Signal to Noise Ratio (PSNR), as is known in the art. As the example illustrates, accuracy is used as a quality indicator of the respective task, while different importance metrics may be used to actually quantify said accuracy of the particular task.

Similar to the case of a single task, the quantization step or the bit depth may be selected as encoding parameters in accordance with the channel importance. Now, in the multiple task case, the importance is given as a function of the mutual information and the task importance. In other words, the channel importance accounts also for possible dependencies between feature channels with respect to the multiple tasks (task-based channel correlations). In case of the encoding parameter being quantization step, the higher the importance of the feature channel, the smaller the quantization step. Therefore, the encoding of the two or more feature channels may be optimized for multiple tasks while accounting both for task dependencies (via mutual information) and preference to one or more specific tasks (via the task importance). As a result, the compression efficiency is improved.

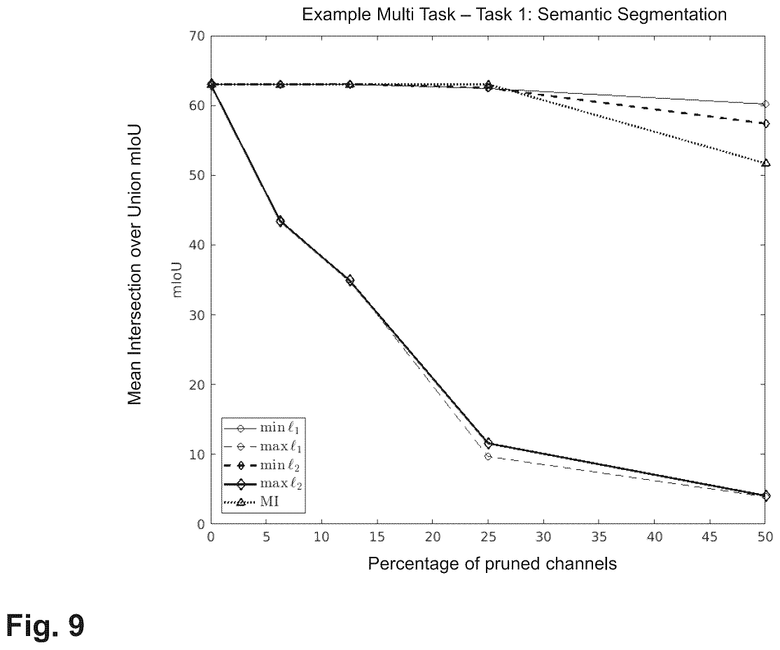

The bit depth, i.e. the amount of bits allocated, may be also selected as encoding parameter, in which case the higher the channel importance the larger the bit depth. In the case of little and/or zero importance, the bit depth may be zero, and corresponds to an extreme version of unequal bit allocation. Feature channel pruning is an extreme version of such an unequal bit allocation, where some feature channels are simply removed from the tensor (equivalent to being allocated zero rate) while others are left intact (not compressed). FIG. 9 shows the accuracy of task 1 (semantic segmentation), measured by mIOU, as a function of the percentage of the feature channels pruned for the network of FIG. 8. Five curves are shown in the figure. The two curves at the bottom correspond to pruning (removing) the channels with the maximum normalized [symbol] ₁ or [symbol] ₂ norm. This leads to a relatively poor accuracy (with mIoU, the higher the better), indicating that channels with larger norms are important. Meanwhile, pruning channels with minimum normalized [symbol] ₁ or [symbol] ₂ norm leads to a better accuracy. Similarly, pruning channels with a minimum mutual information relative to task 1 also leads to a good accuracy. This shows that for semantic segmentation (task 1), normalized [symbol] ₁ or [symbol] ₂ norm and the mutual information are good indicators of the channel importance.

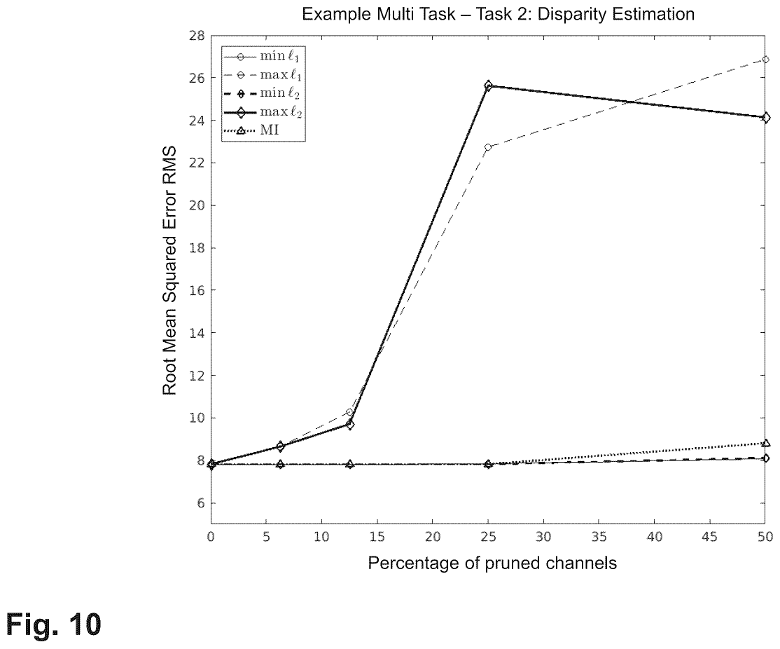

FIG. 10 shows the accuracy of task 2 (disparity estimation), measured by RMSE, as a function of the percentage of the feature channels pruned for the network of FIG. 8. With RMSE, the lower the better. Again, five curves are shown in FIG. 10. The two curves at the top (worst accuracy) correspond to pruning the channels with the maximum normalized [symbol] ₁ or [symbol] ₂ norm. This leads to a relatively poor accuracy, indicating that channels with larger norms are important. Meanwhile, pruning channels with minimum normalized [symbol] ₁ or [symbol] ₂ norm leads to a better accuracy. Similarly, pruning channels with a minimum mutual information relative to task 2 also leads to a good accuracy. This shows that for disparity estimation (task 2), normalized [symbol] ₁ or [symbol] ₂ norm and mutual information are good indicators of channel importance.

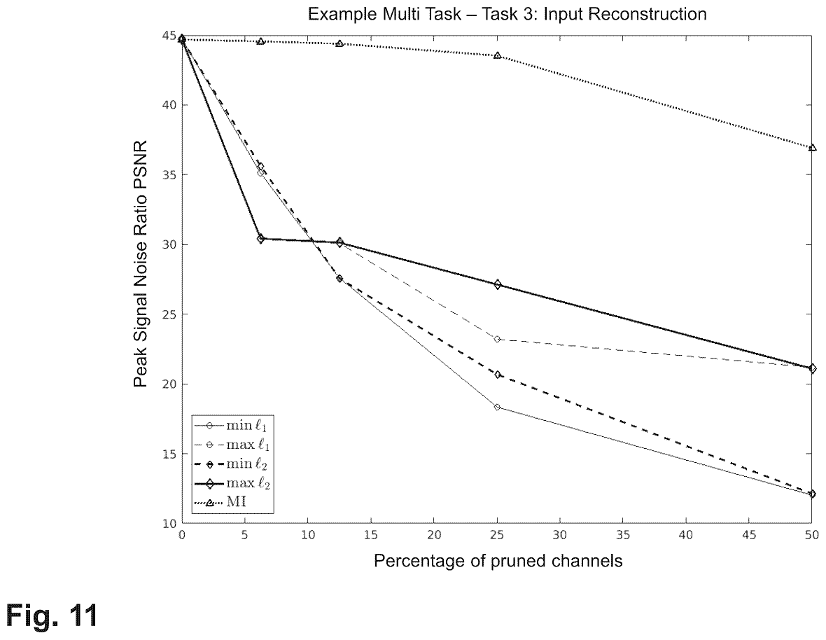

FIG. 11 shows the accuracy of task 3 (input reconstruction), measured by PSNR, as a function of the percentage of the feature channels pruned for the network of FIG. 8. With PSNR, the higher the better. Again, five curves are shown in FIG. 11. The two curves at the bottom (worst accuracy) correspond to pruning the channels with the maximum normalized [symbol] ₁ or [symbol] ₂ norm. This leads to a relatively poor accuracy, indicating that channels with larger norms are important. The next two curves, also near the bottom, correspond to pruning channels with minimum normalized [symbol] ₁ or [symbol] ₂ norm. This leads to a slightly better accuracy. However, pruning channels with a minimum mutual information relative to task 3 leads to a significantly better accuracy, as indicated by the curve at the top. This example shows that normalized [symbol] ₁ or [symbol] ₂ norm are not able to capture channel importance relative to task 3 (input reconstruction), while mutual information is still a good indicator of channel importance. Hence, in multi-task networks, mutual information is more suitable to estimate the task-specific channel importance than normalized [symbol] ₁ or [symbol] ₂ norm.

Referring to FIG. 6, with N channels and M tasks, the task-specific channel importance estimator 631 generates N×M importance estimates, one for each (channel, task) pair, and sends them to the quantization parameters selection block 632. The quantization parameters selection block 632 uses these importance estimates together with the task importance indicator 635 in order to select quantization parameters to improve system performance. The task importance may include a priority of the task and/or a frequency of usage of the tasks. For example, in case of a surveillance application, the task importance may be priority and the respective task being face detection. In another example of monitoring pedestrian traffic (e.g. at a cross-walk), the task importance may be the frequency of the usage of the task, i.e. how often the task has been performed with the task being object detection. The task importance indicator 635 supplies indicators of task importance, for example task weights w₁, w₂, . . . , w_{M}, where wⱼ is the weight (importance) of task j among M tasks. These weights can identify which task(s) is (are) the most important at a particular time. Hence, a particular weight may be put onto one or more tasks and adapted to a specific application (e.g. surveillance). For example, at a given time, task 1 may be the most important, which could be signaled by the task indicator by setting w₁ to be much higher than other wⱼ's. In this case, the quantization parameters selection block 632 would use feature channel importance relative to task 1 in order to select quantization parameters. At another time, task 2 may be the most important, in which case the quantization parameters selection block 632 would use feature channel importance relative to task 2 in order to select quantization parameters.

In one embodiment of FIG. 6, the feature encoder 640 is based on a HEVC encoder. In such an embodiment, the quantization parameter selection block may select HEVC Quantization Parameter (QP) for each feature channel. As one non-limiting example, feature channels may be divided into two groups according to estimated importance for the most important task(s) signaled by the task importance indicator 635: the more important group and the less important group. The more important group of channels may be assigned a smaller QP (1302), resulting in more bits used for (and more accurate reconstruction at the decoder of) channels in this group; while the less important group of channels may be assigned a larger QP (1301), resulting in less bits used for (and less accurate reconstruction at the decoder of) channels in this group. The feature encoder 640 uses the QP values selected by the quantization parameters selection block 632 to control feature tensor compression. If the encoding of feature channels is done in a specific order, that order may also be signaled in the bitstream 645. It will be clear to those skilled in the art that the above example may be extended to more than two groups of channels, multiple QP values, and so on.

The decoding system 680 receives the bitstream 645, which is decoded by the feature decoder 660. In the decoded feature tensor, the feature channels that have been encoded with the lowest quantizer step size (lowest QP) will be reconstructed more accurately than those that have been encoded using larger quantizer step size (larger QP). As a result, the accuracy of the task for which those channels were estimated to be important will be improved compared to other tasks.

Another embodiment relates to the training (or fine-tuning) of multi-task neural network for improved accuracy. Typically, multi-task neural networks are trained without considering compression of their feature tensors. However, lossy compression will result in the loss of information in these feature tensors, which may negatively impact the accuracy of the multiple tasks the network is performing. In order to compensate for this loss of information, it may be advantageous to train (or fine-tune) the network in a manner that considers information loss due to quantization and lossy compression and makes network parameters (weights) more resilient to this type of information loss. One non-limiting example of such training (or fine-tuning) is described below.

Consider a multi-task neural network as shown in FIG. 8. The training of the neural network may be performed in a similar manner as in case of the single task neural network 2100 of FIG. 2, discussed before. Again, the network may be pre-trained in a conventional way, without considering compression of the feature tensor F 625 at the output of the neural network front-end 620. The fine-tuning may start with neural network weights obtained using conventional training. In other words, the weights of the respective layers of the neural network are pre-trained, and hence define an initial state of the neural network. During fine-tuning, images are presented at the network input, and the resulting feature F is computed, followed by determining an importance for each channel.

Then noise is added to F, and the resulting tensor is denoted F. Finally, F is passed to each of the network back-ends (671, 672, 673 in FIG. 8). Each back-end computes its own task-specific error. Accordingly, the neural network is trained in a task-specific manner while accounting for multiple tasks. This may improve the resiliency of neural network parameters for multiple tasks. Let E 1 be the task-specific error of task j. The total error Eₜₒₜₐₗ is then computed as the weighted combination of the task-specific errors:

Eₜₒₜₐₗ=w₁E₁+w₂E₂+ . . . w_{M}E_{M},

where wⱼ is the weight (importance) assigned to task j. In other words, the total error is a weighted sum of the task specific errors. Hence, the total error may be adapted in a flexible manner by using appropriate weights. This improves the fine tuning of the noise-based training, leading to an improved resiliency of the neural network. These task weights may be chosen in several ways including, but not limited to: 1) equal weights; 2) unequal weights, reflecting the importance of each task; 3) the weights could themselves be trainable parameters of the multi-task neural network. Once the total error Eₜₒₜₐₗ is computed, it is used to update network parameters via backpropagation, as is known in the art. Thus, the updating of the neural network parameters is performed in a simple manner, while still accounting for errors specific to multiple tasks. This reduces the complexity of the training.

The noise added to F has two components, e_{q} and e_{c}:

\tilde{F}=F+e_{q}+e_{c}

The role of e_{q} is to model pre-quantization and the role of e_{c} is to model subsequent lossy compression. For the case of unequal bit allocation (via different QP values), e_{c} can model this by introducing different noise energy (variance) into different tensor channels, according to their importance. In one embodiment, e_{q} can be a noise from a uniform distribution, and e_{c} can be a noise from a Gaussian distribution. Depending on task weights, noise variances for e_{c} can be selected in several ways. For example, if task weights are equal (w₁=w₂= . . . =w_{M}), then noise variances may be selected according to the average task-specific importance of each channel (averaged over all tasks). If task weights are unequal, the noise variances may be selected according to the weighted average of task-specific importance of each task (weighted average across all tasks). Alternatively, noise variance may be selected according to the worst-case (largest QP) allowed in the system for each channel. As in the case of single-task networks discussed before, it is expected that fine-tuning will improve the task accuracy in multi-task networks in case of feature tensor compression.

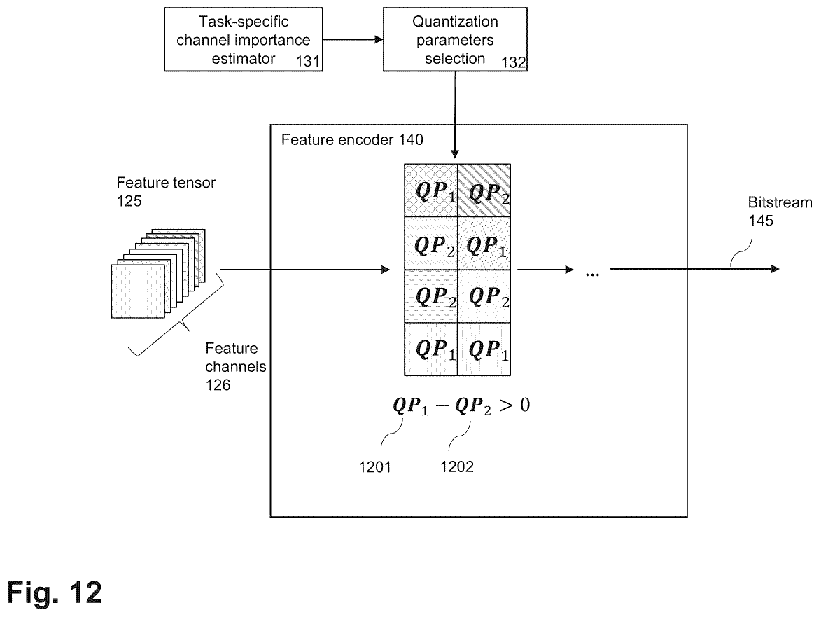

FIG. 12 illustrates an embodiment in which the feature tensor 125 including a plurality of channels 126 is input into feature encoder. As mentioned above, the feature tensor is not necessarily generated in the same module or even device as the feature channel encoding. It may be pre-stored and provided to the feature encoder 140. The channel importance estimator 131 and the quantization parameter selector 132 are similar to those already described above. The feature encoder 140 here illustrates schematically the combination of the channels 126 as tiles into a rectangle of 4 times 2 channel matrix (image). Based on the selection of the quantization parameter (either QP1 1201 or QP2 1202) for each channel, the channels are encoded, each with the quantization parameter indicates on the channel in the figure. Herein, QP1>QP2. The result of the encoding is the bitstream 145.

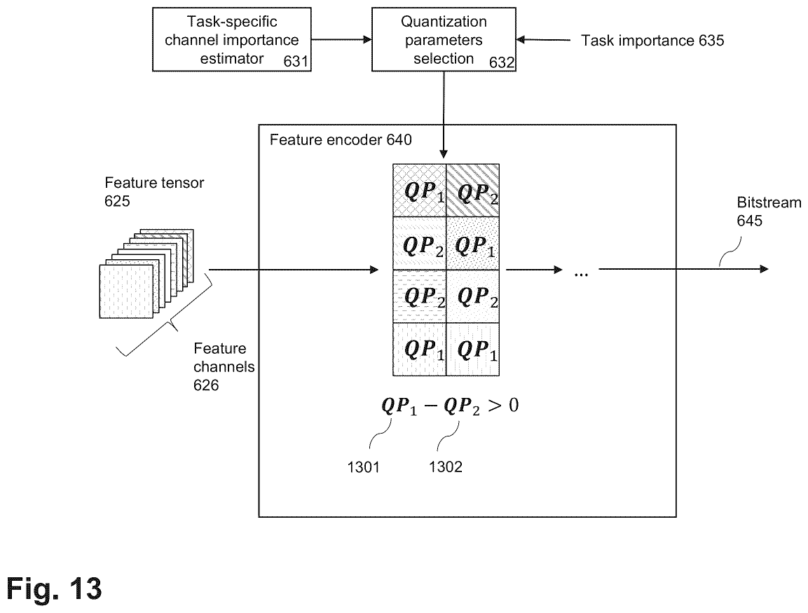

FIG. 13 visualizes an embodiment in which the channel importance 631 used in selecting 632 the encoding parameter(s) is task specific. The remaining portions of the figure are similar to those of FIG. 12. However, herein, for different tasks, the assignment of the QP1 or QP2 to particular channels may differ.

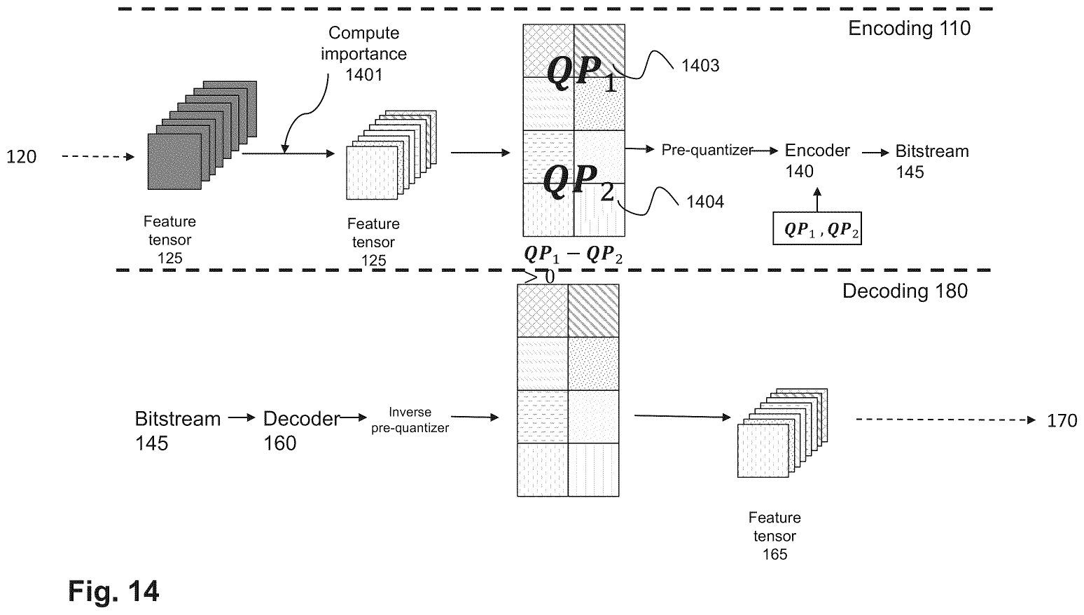

FIG. 14 shows encoding and decoding chain for the single-task neural network. Channels of a feature tensor 125 undergo importance determination 1401. The channels are ordered according to their importance into two groups: those with importance exceeding a threshold are assigned QP1 1403 and those with importance lower than (or equal to) the threshold are assigned QP2 1404. Pre-quantization is then applied. The pre-quantization adjusts the bit depth and may perform rounding or clipping, or the like to represent the features in the desired bit depth (such as 8 bits or 4 bits or any other desired length). Then, the actual lossy coding with the quantization parameters 1403, 1404 is performed to obtain the bitstream 145.

At the decoder, the bitstream is parsed and decoded 160 with the respective encoding parameters 1403, 1404 which may be parsed from the bitstream before parsing the encoded features. The decoded picture with tiles being the feature channels is split again into the channels 165 of the feature tensor and output 170.

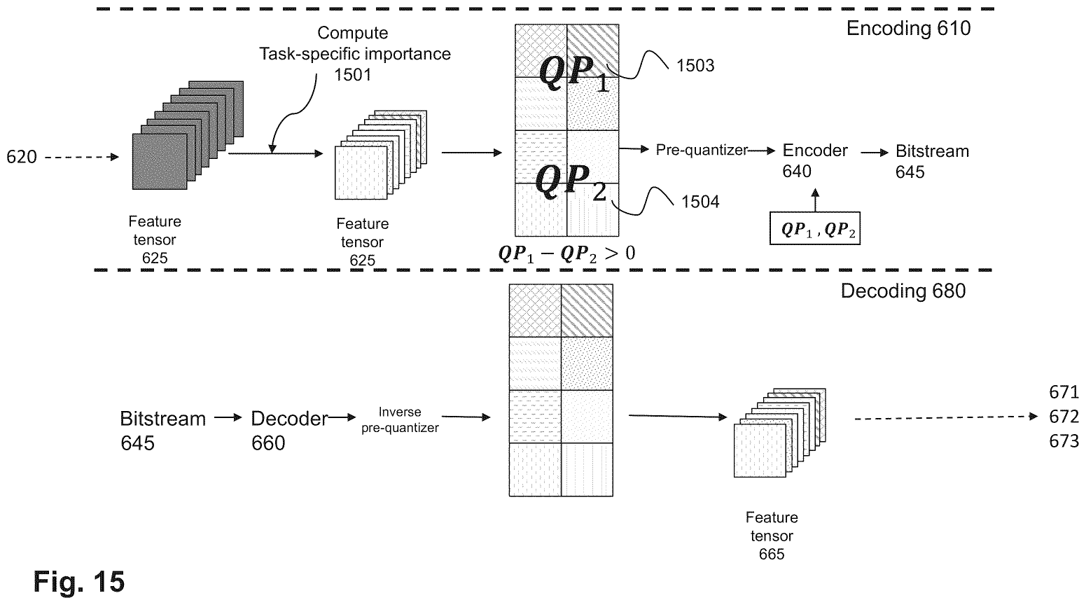

FIG. 15 illustrates encoder and decoder chain for the case in which the importance may differ for different tasks. FIG. 15 is similar as FIG. 14, but it outputs three different feature tensors 671, 672, 673, corresponding to three different tasks for which the neural network is used (e.g. also trained). Not shown in the figure, the assignment of the QPs to the channels may also differ for different tasks.

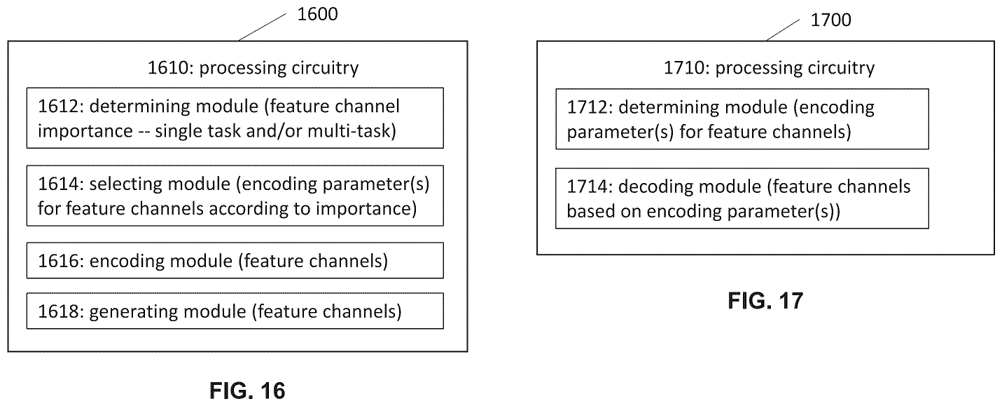

Regarding software and hardware implementations, in the following several possible examples will be provided. FIG. 16 shows an exemplary general implementation of an encoding apparatus 1600 according to one of the above embodiments, in which apparatus 1600 is equipped with processing circuitry 1610 so as to perform the various processing for encoding two or more feature channels. In particular, processing circuitry 1610 may include modules for said processing. For example, determining module 1612 determines (e.g. by estimating) an importance for each of the two or more feature channels, employing an importance metric which may be a p-norm and/or mutual information MI, depending on whether the neural network is trained for a single task or multiple task. Selecting module 1614 then selects one or more encoding parameters based on the channel importance. As discussed before, in case of a high channel importance, the selected encoding parameter may be bit depth, for which a larger bit depth is used as opposed to a less important channel. Encoding module 1616 then uses the respective encoding parameter(s) and encodes the two or more feature channels into a bitstream. It is noted that the feature channels and/or the feature tensor may be already generated and stored on a cloud server, for example. Alternatively, the feature tensor may be generated also by processing circuitry 1610, in which case circuitry 1610 includes a generating module 1618 for generating the two or more feature channels and/or the feature tensor, which includes processing of an input picture 101 as shown in FIG. 1 with one or more layers (e.g. layers 122, 124, 126, 128 in FIG. 2) of neural network 120.

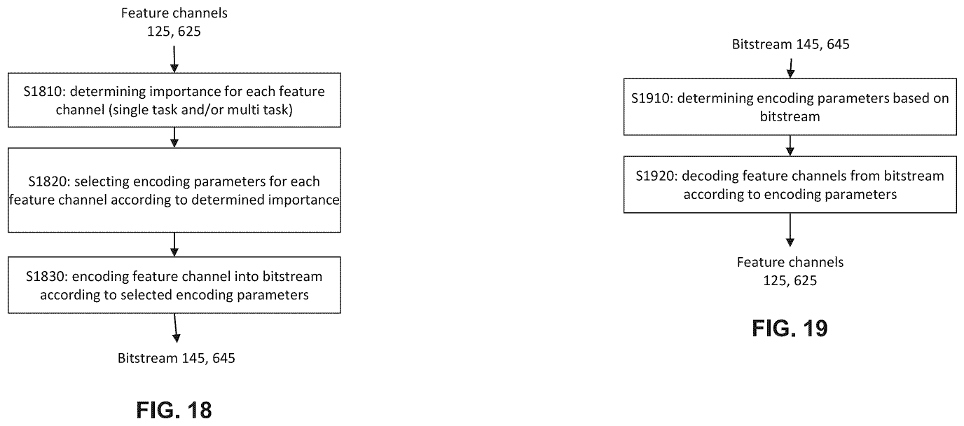

As mentioned before, the encoding of the two or more feature channels may be implemented also in software, in which case a corresponding program has instructions for a computer to perform steps of a corresponding encoding method. FIG. 18 shows an exemplary flowchart according to one of the embodiments that implements the encoding method. In step S1810, an importance of two or more feature channels are determined, followed by a selecting step S1820 where two or more encoding parameters (e.g. bit depth, quantization step size QP etc.) are selected in accordance with the channel importance. For example, the higher the channel importance, the smaller the quantization step size. The determined channel importance may differ for at least two of the two or more feature channels. In step S1830, the two or more feature channels are encoded into bitstream 145 in accordance with the selected one or more selected encoding parameters.

FIG. 17 shows an exemplary implementation of a decoding apparatus 1700 according to one aspect of the present disclosure. Apparatus 1700 may be a part of decoding system 180. Apparatus 1700 is equipped with processing circuitry 1710 so as to perform the various processing for decoding two or more feature channels. In particular, processing circuitry 1710 may include various modules for said processing. For example, determining module 1712 determines one or more encoding parameters for each feature channel based on bitstream 145, with the encoding parameters being different for at least two among the two or more feature channels. As discussed below, the encoding parameters have been selected on the encoder side in accordance with the importance of the feature channels. Hence, information on the channel importance is inherently included in the bitstream, which the decoder side exploits for decoding the two or more feature channels from said bitstream in accordance with the encoding parameters (decoding step S1720). In other words, the channel importance is signaled to the decoder via the bitstream in that the decoder uses the importance-based encoding parameters for decoding the feature channels.

The encoding of the two or more feature channels may be implemented also in software, in which case a corresponding program has instructions for a computer to perform steps of a corresponding decoding method. FIG. 19 shows an exemplary flowchart according to one embodiment of the present disclosure that implements the decoding method. In step S1910, one or more encoding parameters are determined from bitstream 145 for each of two or more feature channels. Then, in step 1920 the two or more feature channels are decoded from the bitstream in accordance with the encoding parameters.

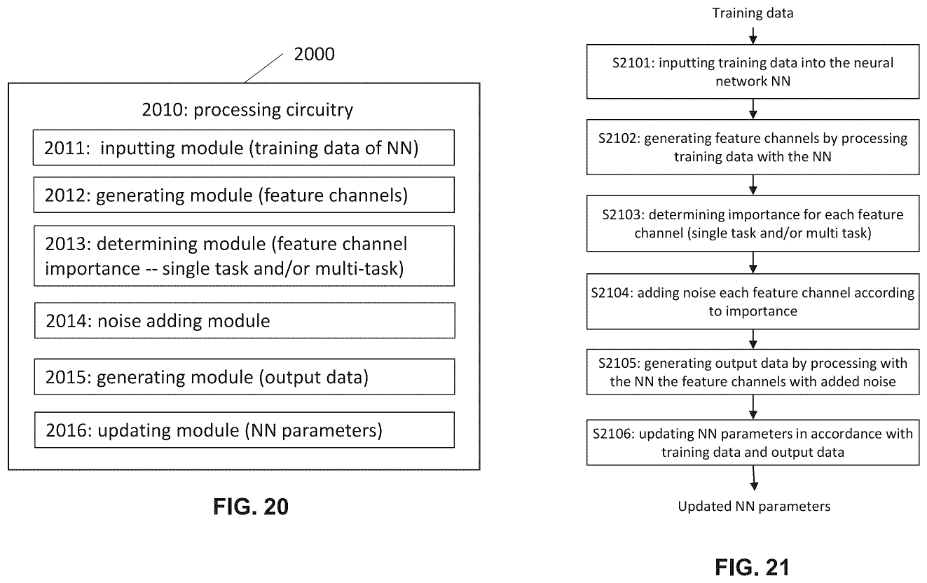

FIG. 20 shows an exemplary implementation of an encoding apparatus 2000 for training according to an embodiment, in which apparatus 2000 is equipped with processing circuitry 2010 so as to perform the various processing for training a neural network for encoding two or more feature channels. Processing circuitry 2010 may include various modules for said processing. For example, inputting module 2011 takes as input training data which may be an input picture 101. Generating module 2012 then generates two or more feature channels by processing the training data with one or more layers (e.g. layers 122, 124, 126, 128 in FIG. 2) of the neural network 120. Then, an importance for each of the two or more feature channels is determined by determining module 2013. The importance may be different for at least two among the two or more feature channels. Noise adding module 2014 adds noise (e.g. pre-quantization noise and/or lossy compression noise) to the feature channels. Output data are then generated by generating module 2015 by processing the feature channels with the added noise with the one or more layers of the neural network. Finally, updating module 2016 updates one or more parameters of the neural network in accordance with the training data and the output data.

As mentioned above, the processing performed by the training apparatus for encoding the two or more feature channels may be implemented also in software. In this case, a corresponding program has instructions for a computer to perform steps of a corresponding training method. FIG. 21 shows an exemplary flowchart according to one of the embodiments that implements the training method. In step S2101, neural network 120 takes training data (e.g. input picture 101) as input, and generates in step S2102 two or more feature channels by processing the training data with one or more layers of the neural network. The one or more layers may be layers 122, 124, 126, 128 of neural network 120 of FIG. 2. This is followed by step S2103 where an importance for each of the two or more feature channels is determined and adding noise to the feature channel in accordance with the importance (step S2104). The importance differs for at least two among the two or more feature channels. The feature channels with the added noise are then processed with the one or more layers of the neural network so as to generate output data in step S2105. In accordance with the training data and the output data, one or more parameters of the neural network are updated (step S2106).

The person skilled in the art will understand that the “blocks” (“units”) or “modules” of the various figures (method and apparatus) represent or describe functionalities of embodiments of the present disclosure (rather than necessarily individual “units” in hardware or software) and thus describe equally functions or features of apparatus embodiments as well as method embodiments.

The terminology of “units” is merely used for illustrative purposes of the functionality of embodiments of the encoder/decoder and are not intended to liming the disclosure.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, optical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, the functional units in the embodiments of the present disclosure may be integrated into one processing unit, or each of the units may exist alone physically, or two or more units are integrated into one unit.

Some further implementations in hardware and software are described in the following.

As mentioned above, HEVC may be used to encode the feature channels in some embodiments. The present disclosure is not limited to the examples presented above. It is conceivable to also employ embodiments of the present disclosure within a codec such as the HEVC or another codec. For example, the feature channels may be feature channels obtained by applying neural network to a sparse optical flow to obtain a dense optical flow or to perform some in-loop filtering or other parts of encoding and/or decoding. Accordingly, in the following, the HEVC function is briefly described.

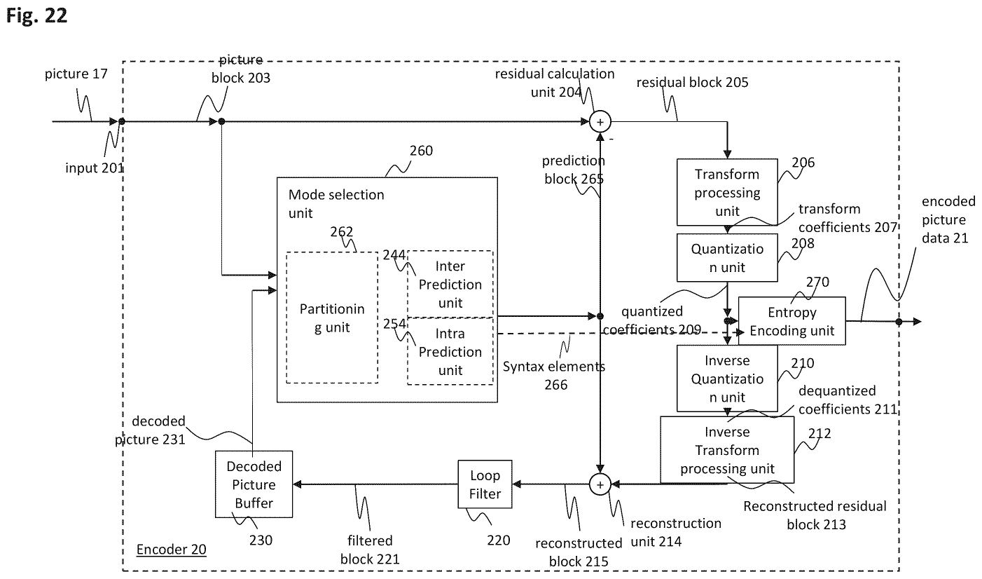

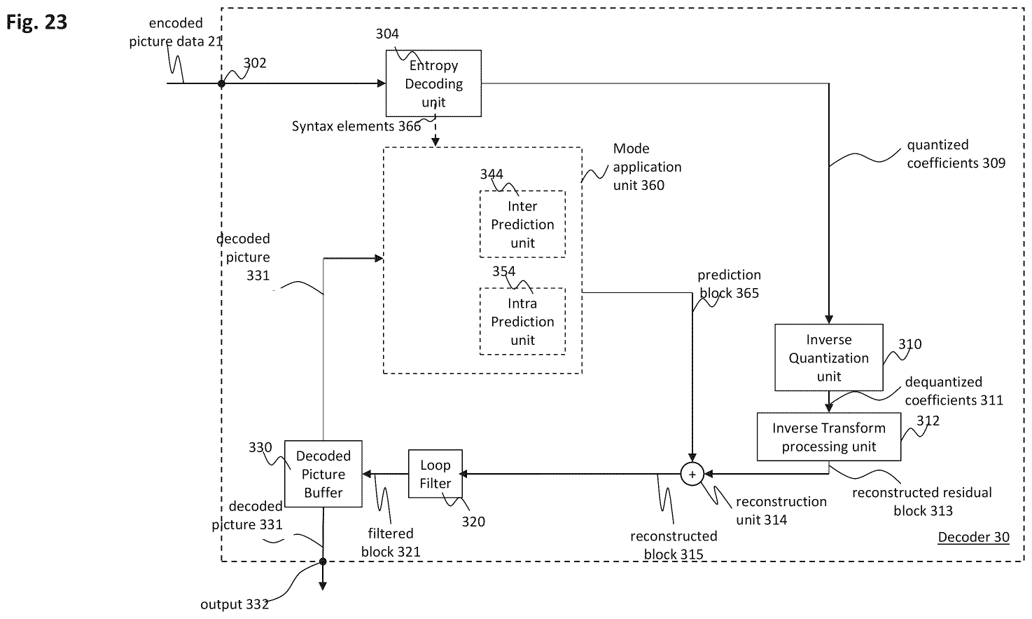

An implementation example of a HEVC encoder and decoder is shown FIG. 22 and FIG. 23 (the description and figures apply correspondingly to a VVC encoder and decoder or other video codecs). FIG. 22 shows a schematic block diagram of an example video encoder 20 that is configured to implement the techniques of the present disclosure. In the example of FIG. 22, the video encoder 20 comprises an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272). The mode selection unit 260 may include an inter prediction unit 244, an intra prediction unit 254 and a partitioning unit 262. Inter prediction unit 244 may include a motion estimation unit and a motion compensation unit (not shown). A video encoder 20 as shown in FIG. 22 may also be referred to as hybrid video encoder or a video encoder according to a hybrid video codec.

The inverse quantization unit 210, the inverse transform processing unit 212, the reconstruction unit 214, the loop filter 220, the decoded picture buffer (DPB) 230, the inter prediction unit 244 and the intra-prediction unit 254 are also referred to forming the “built-in decoder” of video encoder 20.

The encoder 20 may be configured to receive, e.g. via input 201, a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components.

Embodiments of the video encoder 20 may comprise a picture partitioning unit 262 configured to partition the picture 17 into a plurality of (typically non-overlapping) picture blocks 203. These blocks may also be referred to as root blocks, macro blocks (H.264/AVC) or coding tree blocks (CTB) or coding tree units (CTU) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks.

Embodiments of the video encoder 20 as shown in FIG. 22 may be configured to encode the picture 17 block by block, e.g. the encoding and prediction is performed per block 203.

The quantization unit 208 may be configured to quantize the transform coefficients 207 to obtain quantized coefficients 209, e.g. by applying scalar quantization or vector quantization. The quantized coefficients 209 may also be referred to as quantized transform coefficients 209 or quantized residual coefficients 209.

The quantization process may reduce the bit depth associated with some or all of the transform coefficients 207. For example, an n-bit transform coefficient may be rounded down to an m-bit Transform coefficient during quantization, where n is greater than m. The degree of quantization may be modified by adjusting a quantization parameter (QP). For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and a corresponding and/or the inverse dequantization, e.g. by inverse quantization unit 210, may include multiplication by the quantization step size. Embodiments according to some standards, e.g. HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g. in a bitstream. The quantization is a lossy operation, wherein the loss increases with increasing quantization step sizes.

Embodiments of the video encoder 20 (respectively quantization unit 208) may be configured to output quantization parameters (QP), e.g. directly or encoded via the entropy encoding unit 270, so that, e.g., the video decoder 30 may receive and apply the quantization parameters for decoding.

The inverse quantization unit 210 is configured to apply the inverse quantization of the quantization unit 208 on the quantized coefficients to obtain dequantized coefficients 211, e.g. by applying the inverse of the quantization scheme applied by the quantization unit 208 based on or using the same quantization step size as the quantization unit 208. The dequantized coefficients 211 may also be referred to as dequantized residual coefficients 211 and correspond—although typically not identical to the transform coefficients due to the loss by quantization—to the transform coefficients 207.

The reconstruction unit 214 (e.g. adder or summer 214) is configured to add the transform block 213 (i.e. reconstructed residual block 213) to the prediction block 265 to obtain a reconstructed block 215 in the sample domain, e.g. by adding—sample by sample—the sample values of the reconstructed residual block 213 and the sample values of the prediction block 265.

The above mentioned quantization parameter is one of the possible encoding parameters that may be set based on the importance according to some embodiments. Alternatively or in addition, the partitioning, the prediction type or loop-filtering may be used.

The loop filter unit 220 (or short “loop filter” 220), is configured to filter the reconstructed block 215 to obtain a filtered block 221, or in general, to filter reconstructed samples to obtain filtered samples. The loop filter unit is, e.g., configured to smooth pixel transitions, or otherwise improve the video quality. The loop filter unit 220 may comprise one or more loop filters such as a de-blocking filter, a sample-adaptive offset (SAO) filter or one or more other filters, e.g. a bilateral filter, an adaptive loop filter (ALF), a sharpening, a smoothing filters or a collaborative filters, or any combination thereof. Although the loop filter unit 220 is shown in FIG. 22 as being an in loop filter, in other configurations, the loop filter unit 220 may be implemented as a post loop filter. The filtered block 221 may also be referred to as filtered reconstructed block 221.

Embodiments of the video encoder 20 (respectively loop filter unit 220) may be configured to output loop filter parameters (such as sample adaptive offset information), e.g. directly or encoded via the entropy encoding unit 270, so that, e.g., a decoder 30 may receive and apply the same loop filter parameters or respective loop filters for decoding.

The decoded picture buffer (DPB) 230 may be a memory that stores reference pictures, or in general reference picture data, for encoding video data by video encoder 20. The DPB 230 may be formed by any of a variety of memory devices, such as dynamic random access memory (DRAM), including synchronous DRAM (SDRAM), magnetoresistive RAM (MRAM), resistive RAM (RRAM), or other types of memory devices.

The mode selection unit 260 comprises partitioning unit 262, inter-prediction unit 244 and intra-prediction unit 254, and is configured to receive or obtain original picture data, e.g. an original block 203 (current block 203 of the current picture 17), and reconstructed picture data, e.g. filtered and/or unfiltered reconstructed samples or blocks of the same (current) picture and/or from one or a plurality of previously decoded pictures, e.g. from decoded picture buffer 230 or other buffers (e.g. line buffer, not shown). The reconstructed picture data is used as reference picture data for prediction, e.g. inter-prediction or intra-prediction, to obtain a prediction block 265 or predictor 265.

Mode selection unit 260 may be configured to determine or select a partitioning for a current block prediction mode (including no partitioning) and a prediction mode (e.g. an intra or inter prediction mode) and generate a corresponding prediction block 265, which is used for the calculation of the residual block 205 and for the reconstruction of the reconstructed block 215.

Embodiments of the mode selection unit 260 may be configured to select the partitioning and the prediction mode (e.g. from those supported by or available for mode selection unit 260), which provide the best match or in other words the minimum residual (minimum residual means better compression for transmission or storage), or a minimum signaling overhead (minimum signaling overhead means better compression for transmission or storage), or which considers or balances both. The mode selection unit 260 may be configured to determine the partitioning and prediction mode based on rate distortion optimization (RDO), i.e. select the prediction mode which provides a minimum rate distortion. Terms like “best”, “minimum”, “optimum” etc. in this context do not necessarily refer to an overall “best”, “minimum”, “optimum”, etc. but may also refer to the fulfillment of a termination or selection criterion like a value exceeding or falling below a threshold or other constraints leading potentially to a “sub-optimum selection” but reducing complexity and processing time. The RDO may be also used to select one or more parameters based on the importance determined.

In other words, the partitioning unit 262 may be configured to partition the block 203 into smaller block partitions or sub-blocks (which form again blocks), e.g. iteratively using quad-tree-partitioning (QT), binary partitioning (BT) or triple-tree-partitioning (TT) or any combination thereof, and to perform, e.g., the prediction for each of the block partitions or sub-blocks, wherein the mode selection comprises the selection of the tree-structure of the partitioned block 203 and the prediction modes are applied to each of the block partitions or sub-blocks.

The partitioning unit 262 may partition (or split) a current block 203 into smaller partitions, e.g. smaller blocks of square or rectangular size. These smaller blocks (which may also be referred to as sub-blocks) may be further partitioned into even smaller partitions. This is also referred to tree-partitioning or hierarchical tree-partitioning, wherein a root block, e.g. at root tree-level 0 (hierarchy-level 0, depth 0), may be recursively partitioned, e.g. partitioned into two or more blocks of a next lower tree-level, e.g. nodes at tree-level 1 (hierarchy-level 1, depth 1), wherein these blocks may be again partitioned into two or more blocks of a next lower level, e.g. tree-level 2 (hierarchy-level 2, depth 2), etc. until the partitioning is terminated, e.g. because a termination criterion is fulfilled, e.g. a maximum tree depth or minimum block size is reached. Blocks which are not further partitioned are also referred to as leaf-blocks or leaf nodes of the tree. A tree using partitioning into two partitions is referred to as binary-tree (BT), a tree using partitioning into three partitions is referred to as ternary-tree (TT), and a tree using partitioning into four partitions is referred to as quad-tree (QT).

As mentioned before, the term “block” as used herein may be a portion, in particular a square or rectangular portion, of a picture. With reference, for example, to HEVC and VVC, the block may be or correspond to a coding tree unit (CTU), a coding unit (CU), prediction unit (PU), and transform unit (TU) and/or to the corresponding blocks, e.g. a coding tree block (CTB), a coding block (CB), a transform block (TB) or prediction block (PB).

For example, a coding tree unit (CTU) may be or comprise a CTB of luma samples, two corresponding CTBs of chroma samples of a picture that has three sample arrays, or a CTB of samples of a monochrome picture or a picture that is coded using three separate colour planes and syntax structures used to code the samples. Correspondingly, a coding tree block (CTB) may be an N×N block of samples for some value of N such that the division of a component into CTBs is a partitioning. A coding unit (CU) may be or comprise a coding block of luma samples, two corresponding coding blocks of chroma samples of a picture that has three sample arrays, or a coding block of samples of a monochrome picture or a picture that is coded using three separate colour planes and syntax structures used to code the samples. Correspondingly a coding block (CB) may be an M×N block of samples for some values of M and N such that the division of a CTB into coding blocks is a partitioning.

In embodiments, e.g., according to HEVC, a coding tree unit (CTU) may be split into CUs by using a quad-tree structure denoted as coding tree. The decision whether to code a picture area using inter-picture (temporal) or intra-picture (spatial) prediction is made at the CU level. Each CU can be further split into one, two or four PUs according to the PU splitting type. Inside one PU, the same prediction process is applied and the relevant information is transmitted to the decoder on a PU basis. After obtaining the residual block by applying the prediction process based on the PU splitting type, a CU can be partitioned into transform units (TUs) according to another quadtree structure similar to the coding tree for the CU.

Different sizes of the blocks, or maximum and/or minimum of the blocks obtained by partitioning may be also part of the encoding parameters, as different sizes of blocks will result in different coding efficiencies.

In one example, the mode selection unit 260 of video encoder 20 may be configured to perform any combination of the partitioning techniques described herein.

As described above, the video encoder 20 is configured to determine or select the best or an optimum prediction mode from a set of (e.g. pre-determined) prediction modes. The set of prediction modes may comprise, e.g., intra-prediction modes and/or inter-prediction modes.

FIG. 23 shows an example of a video decoder 30 that is configured to implement the techniques of this present application. The video decoder 30 is configured to receive encoded picture data 21 (e.g. encoded bitstream 21), e.g. encoded by encoder 20, to obtain a decoded picture 331. The encoded picture data or bitstream comprises information for decoding the encoded picture data, e.g. data that represents picture blocks of an encoded video slice (and/or tile groups or tiles) and associated syntax elements.

In the example of FIG. 23, the decoder 30 comprises an entropy decoding unit 304, an inverse quantization unit 310, an inverse transform processing unit 312, a reconstruction unit 314 (e.g. a summer 314), a loop filter 320, a decoded picture buffer (DBP) 330, a mode application unit 360, an inter prediction unit 344 and an intra prediction unit 354. Inter prediction unit 344 may be or include a motion compensation unit. Video decoder 30 may, in some examples, perform a decoding pass generally reciprocal to the encoding pass described with respect to video encoder 100 from FIG. 22.

As explained with regard to the encoder 20, the inverse quantization unit 210, the inverse transform processing unit 212, the reconstruction unit 214 the loop filter 220, the decoded picture buffer (DPB) 230, the inter prediction unit 344 and the intra prediction unit 354 are also referred to as forming the “built-in decoder” of video encoder 20. Accordingly, the inverse quantization unit 310 may be identical in function to the inverse quantization unit 110, the inverse transform processing unit 312 may be identical in function to the inverse transform processing unit 212, the reconstruction unit 314 may be identical in function to reconstruction unit 214, the loop filter 320 may be identical in function to the loop filter 220, and the decoded picture buffer 330 may be identical in function to the decoded picture buffer 230. Therefore, the explanations provided for the respective units and functions of the video encoder apply correspondingly to the respective units and functions of the video decoder 30.

The entropy decoding unit 304 is configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 23), e.g. any or all of inter prediction parameters (e.g. reference picture index and motion vector), intra prediction parameter (e.g. intra prediction mode or index), transform parameters, quantization parameters, loop filter parameters, and/or other syntax elements.

The inverse quantization unit 310 may be configured to receive quantization parameters (QP) (or in general information related to the inverse quantization) and quantized coefficients from the encoded picture data 21 (e.g. by parsing and/or decoding, e.g. by entropy decoding unit 304) and to apply based on the quantization parameters an inverse quantization on the decoded quantized coefficients 309 to obtain dequantized coefficients 311, which may also be referred to as transform coefficients 311. The inverse quantization process may include use of a quantization parameter determined by video encoder 20 for each video block in the video slice (or tile or tile group) to determine a degree of quantization and, likewise, a degree of inverse quantization that should be applied.

Inverse transform processing unit 312 may be configured to receive dequantized coefficients 311, also referred to as transform coefficients 311, and to apply a transform to the dequantized coefficients 311 in order to obtain reconstructed residual blocks 213 in the sample domain. The reconstructed residual blocks 213 may also be referred to as transform blocks 313.

The reconstruction unit 314 (e.g. adder or summer 314) may be configured to add the reconstructed residual block 313, to the prediction block 365 to obtain a reconstructed block 315 in the sample domain, e.g. by adding the sample values of the reconstructed residual block 313 and the sample values of the prediction block 365.

The loop filter unit 320 (either in the coding loop or after the coding loop) is configured to filter the reconstructed block 315 to obtain a filtered block 321, e.g. to smooth pixel transitions, or otherwise improve the video quality. The loop filter unit 320 may comprise one or more loop filters such as a de-blocking filter, a sample-adaptive offset (SAO) filter or one or more other filters, e.g. a bilateral filter, an adaptive loop filter (ALF), a sharpening, a smoothing filters or a collaborative filters, or any combination thereof. Although the loop filter unit 320 is shown in FIG. 23 as being an in loop filter, in other configurations, the loop filter unit 320 may be implemented as a post loop filter.

The inter prediction unit 344 may be identical to the inter prediction unit 244 (in particular to the motion compensation unit) and the intra prediction unit 354 may be identical to the inter prediction unit 254 in function, and performs split or partitioning decisions and prediction based on the partitioning and/or prediction parameters or respective information received from the encoded picture data 21 (e.g. by parsing and/or decoding, e.g. by entropy decoding unit 304). Mode application unit 360 may be configured to perform the prediction (intra or inter prediction) per block based on reconstructed pictures, blocks or respective samples (filtered or unfiltered) to obtain the prediction block 365.

Mode application unit 360 is configured to determine the prediction information for a video block of the current video slice by parsing the motion vectors or related information and other syntax elements, and uses the prediction information to produce the prediction blocks for the current video block being decoded.

The embodiments of the video decoder 30 as shown in FIG. 23 may be configured to partition and/or decode the picture by using slices (also referred to as video slices), wherein a picture may be partitioned into or decoded using one or more slices (typically non-overlapping), and each slice may comprise one or more blocks (e.g. CTUs).

Embodiments of the video decoder 30 as shown in FIG. 23 may be configured to partition and/or decode the picture by using tile groups (also referred to as video tile groups) and/or tiles (also referred to as video tiles), wherein a picture may be partitioned into or decoded using one or more tile groups (typically non-overlapping), and each tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Other variations of the video decoder 30 can be used to decode the encoded picture data 21. For example, the decoder 30 can produce the output video stream without the loop filtering unit 320. For example, a non-transform based decoder 30 can inverse-quantize the residual signal directly without the inverse-transform processing unit 312 for certain blocks or frames. In another implementation, the video decoder 30 can have the inverse-quantization unit 310 and the inverse-transform processing unit 312 combined into a single unit.

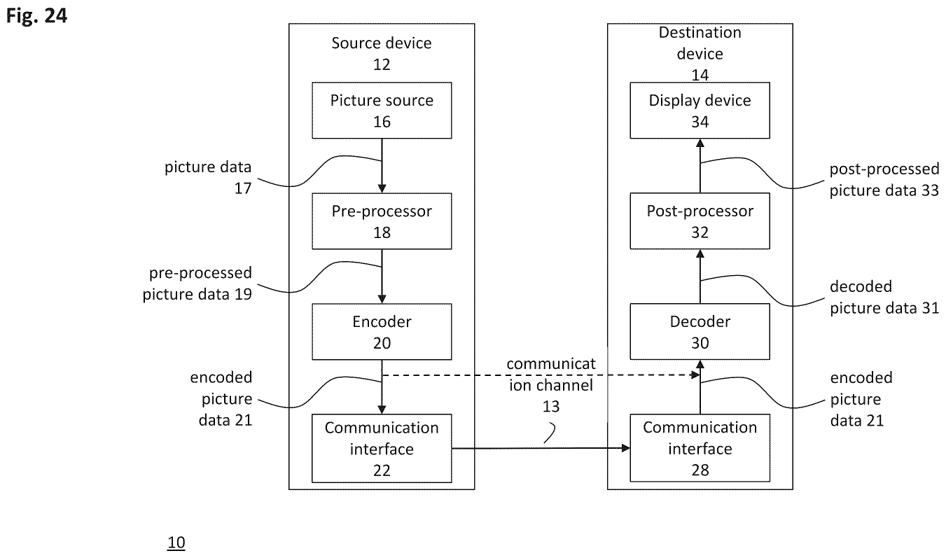

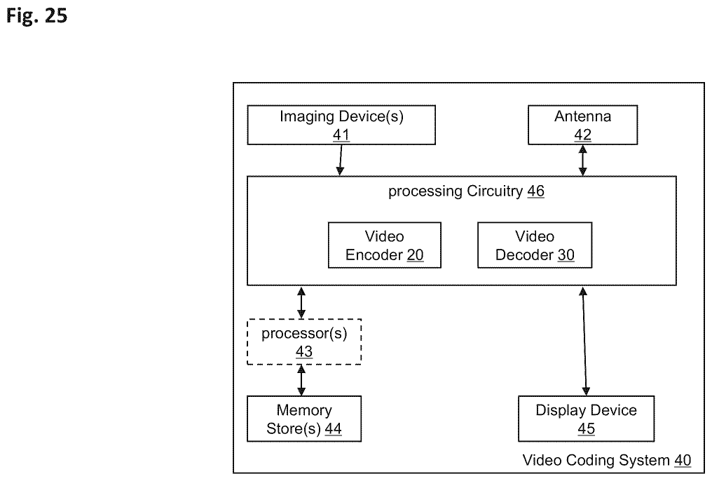

In the following embodiments of a video coding system 10, a video encoder 20 and a video decoder 30 are described based on FIGS. 24 and 25, with reference to the above mentioned FIGS. 22 and 23.

FIG. 24 is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 24, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component.

The video encoder 20 is configured to receive the pre-processed picture data 19 and provide encoded picture data 21 (further details were described above, e.g., based on FIG. 22, which may be further modified by replacing the loop filter with a loop CNN filter similarly as done in FIG. 23 for the decoder).

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 24 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

The decoder 30 is configured to receive the encoded picture data 21 and provide decoded picture data 31 or a decoded picture 31 (further details were described above, e.g., based on FIG. 23 or FIG. 24).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 24 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 24 may vary depending on the actual device and application.

The encoder 20 (e.g. a video encoder 20) or the decoder 30 (e.g. a video decoder 30) or both encoder 20 and decoder 30 may be implemented via processing circuitry as shown in FIG. 25, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules as discussed with respect to encoder 20 of FIG. 25 and/or any other encoder system or subsystem described herein. The decoder 30 may be implemented via processing circuitry 46 to embody the various modules as discussed with respect to decoder 30 of FIG. 23 (or FIG. 24) and/or any other decoder system or subsystem described herein. The processing circuitry may be configured to perform the various operations as discussed later. As shown in FIG. 25, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 25.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 24 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, embodiments of the present disclosure are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the present disclosure are not limited to HEVC or VVC.

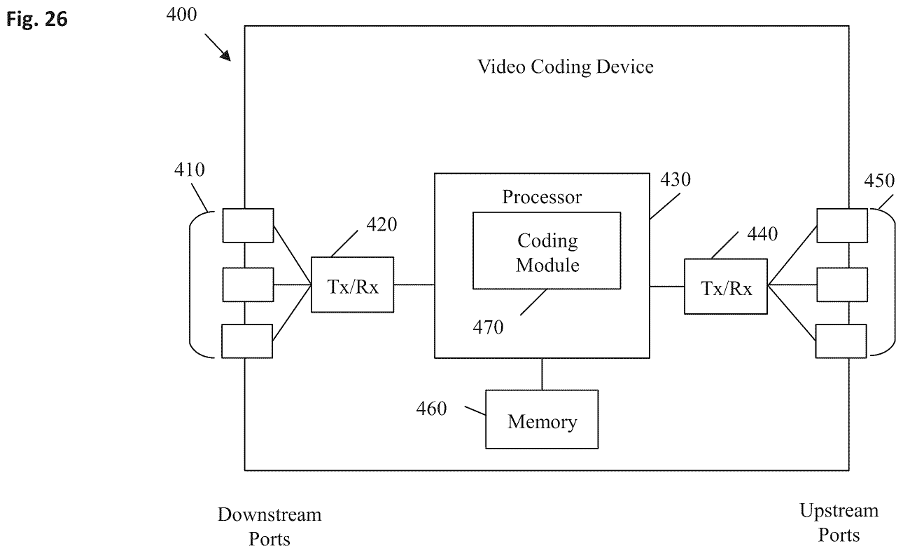

FIG. 26 is a schematic diagram of a video coding device 400 according to an embodiment of the disclosure. The video coding device 400 is suitable for implementing the disclosed embodiments as described herein. In an embodiment, the video coding device 400 may be a decoder such as video decoder 30 of FIG. 24 or an encoder such as video encoder 20 of FIG. 22.

The video coding device 400 comprises ingress ports 410 (or input ports 410) and receiver units (Rx) 420 for receiving data; a processor, logic unit, or central processing unit (CPU) 430 to process the data; transmitter units (Tx) 440 and egress ports 450 (or output ports 450) for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM).

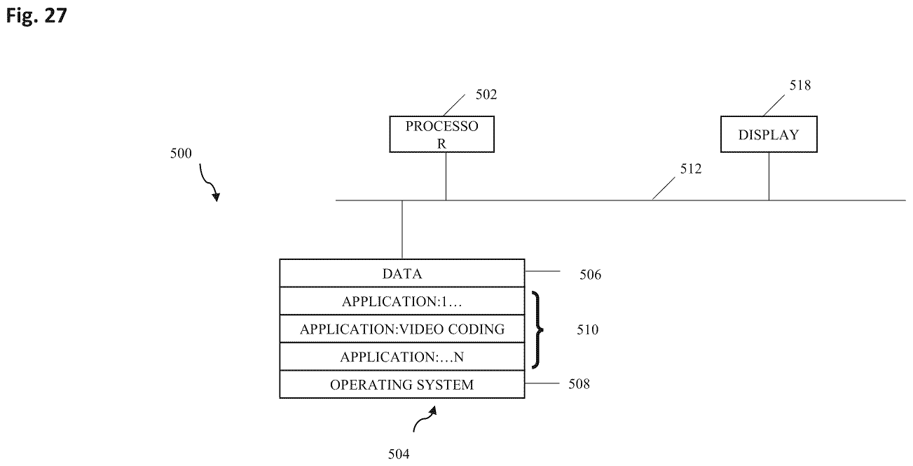

FIG. 27 is a simplified block diagram of an apparatus 500 that may be used as either or both of the source device 12 and the destination device 14 from FIG. 24 according to an exemplary embodiment.

A processor 502 in the apparatus 500 can be a central processing unit. Alternatively, the processor 502 can be any other type of device, or multiple devices, capable of manipulating or processing information now-existing or hereafter developed. Although the disclosed implementations can be practiced with a single processor as shown, e.g., the processor 502, advantages in speed and efficiency can be achieved using more than one processor.

A memory 504 in the apparatus 500 can be a read only memory (ROM) device or a random access memory (RAM) device in an implementation. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described herein, including the encoding and decoding using a neural network and the encoding and decoding the feature channels with different encoding parameters.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, the secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

Although embodiments of the present disclosure have been primarily described based on video coding, it should be noted that embodiments of the coding system 10, encoder and decoder 30 (and correspondingly the system 10) and the other embodiments described herein may also be configured for still picture processing or coding, i.e. the processing or coding of an individual picture independent of any preceding or consecutive picture as in video coding. In general only inter-prediction units 244 (encoder) and 344 (decoder) may not be available in case the picture processing coding is limited to a single picture 17. All other functionalities (also referred to as tools or technologies) of the video encoder 20 and video decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Summarizing, the present disclosure relates to methods and apparatuses for compression of feature tensors of a neural network. One or more encoding parameters for encoding the channels of a feature tensor are selected according to the importance of the channels. This enables unequal bit allocation according to the importance. Furthermore, the deployed neural network may be trained or fine-tuned considering the effect of encoding noise applied to the intermediate feature tensors. Such encoding and modified training methods may be advantageous e.g. for employment in a collaborative intelligence framework.

### LIST OF SOME REFERENCE SIGNS

FIG. 1
101 Input data
110 Encoding system
120 Neural network front end
125 Feature tensor
130 Quantization control processor
131 Channel importance estimator
132 Quantization parameters selection
140 Feature encoder
145 Bitstream
150 Transmission medium
160 Feature decoder
165 Reconstructed feature tensor
170 Neural network back-end
180 Decoding system
191 Output data

FIG. 2
120 Neural network front end
170 Neural network back-end

FIG. 6
601 Input data
610 Encoding system
620 Neural network front end
625 Feature tensor
630 Quantization control processor
631 Task-specific channel importance estimator
632 Quantization parameters selection
640 Feature encoder
645 Bitstream
650 Transmission medium
660 Feature decoder
665 Reconstructed feature tensor
671 Neural network back-end #1
672 Neural network back-end #2
673 Neural network back-end #3
680 Decoding system
691 Output data
692 Output data
693 Output data

FIG. 7
601 Input data
610 Encoding system
620 Neural network front end
625 Feature tensor
630 Quantization control processor
631 Task-specific channel importance estimator
632 Quantization parameters selection
640 Feature encoder
645 Bitstream
650 Transmission medium
660 Feature decoder
665 Reconstructed feature tensor
671 Neural network back-end #1
672 Neural network back-end #2
673 Neural network back-end #3
680 Decoding system

FIG. 8
620 Neural network front end
671 Neural network back-end #1
672 Neural network back-end #2
673 Neural network back-end #3
691 Output data
692 Output data
693 Output data

What is claimed is:

1. An apparatus for encoding two or more feature channels of a neural network into a bitstream, the apparatus comprising:
a memory configured to store instructions; and
a processor coupled to the memory and configured to execute the instructions to cause the apparatus to:
for each of the two or more feature channels,
determine importance of the two or more feature channels;
select one or more encoding parameters for the feature channel according to the determined importance; and
encode the feature channel into the bitstream according to the selected one or more encoding parameters,
wherein the determined importance differs for at least two feature channels among the two or more feature channels.

2. The apparatus according to claim 1, wherein the processor is further configured to execute the instructions to cause the apparatus to:
generate the two or more feature channels, including processing an input picture with one or more layers of the neural network.

3. The apparatus according to claim 1, wherein the one or more encoding parameters include any of coding unit size, prediction unit size, bit depth, and quantization step.

4. The apparatus according to claim 1, wherein the two or more feature channels are for a single-task of the neural network, and
the processor is configured to execute the instructions to cause the apparatus to: determine the importance for the single task being accuracy of the neural network.

5. The apparatus according to claim 4, wherein the determining of the importance of the two or more feature channels is based on an importance metric.

6. The apparatus according to claim 5, wherein the importance metric includes a sum of absolute values of the feature channel.

7. The apparatus according to claim 1, wherein
the one or more encoding parameters include a quantization step size which is a quantization parameter (QP); and
the higher the importance of the feature channel, the lower the QP.

8. The apparatus according to claim 1, wherein
the one or more encoding parameters include a bit depth; and
the higher the importance of the feature channel, the larger the bit depth.

9. The apparatus according to claim 1, wherein
the two or more feature channels are for multiple tasks of the neural network, and
the processor is further configured to execute the instructions to cause the apparatus to: determine the importance of the feature channel for each of the multiple tasks.

10. The apparatus according to claim 9, wherein the determining of the importance includes estimating mutual information for each pair of the feature channels and the multiple tasks,
wherein the importance includes a task importance of a task among the multiple tasks, and
wherein the task importance includes a priority of the task and/or a frequency of usage of the task.

11. The apparatus according to claim 9, wherein
the processor is configured to execute the instructions to cause the apparatus to: select a quantization step or the bit depth as the one or more encoding parameters;
the higher the importance of the feature channel, the smaller the quantization step; and
the importance is given as a function of the mutual information and the task importance.

12. The apparatus according to claim 1, wherein the neural network is trained for one or more of picture segmentation, object recognition, object classification, disparity estimation, depth map estimation, face detection, face recognition, pose estimation, object tracking, action recognition, event detection, prediction, and picture reconstruction.

13. The apparatus according to claim 1, wherein the processor is configured to execute the instructions to cause the apparatus to:
for each feature channel,
determine whether the importance of the feature channel exceeds a predetermined threshold;
based on the importance of the feature channel exceeding the predetermined threshold, selecting for the feature channel the at least one encoding parameter leading to a first quality;
based on the importance of the feature channel not exceeding the predetermined threshold, selecting for the feature channel the at least one encoding parameter leading to a second quality lower than the first quality.

14. An apparatus for decoding two or more feature channels of a neural network from a bitstream, the apparatus comprising:
a memory configured to store instructions; and
a processor coupled to the memory and configured to execute the instructions to cause the apparatus to:
for each feature channel,
determine one or more encoding parameters based on the bitstream; and
decode from the bitstream the feature channel based on the determined one or more encoding parameters;
wherein the encoding parameters differs for at least two among the two or more feature channels.

15. A method for encoding two or more feature channels of a neural network into a bitstream, wherein the method is applied to an encoding apparatus and comprises:
for each of the two or more feature channels,
determining importance of the two or more feature channels;
selecting one or more encoding parameters for the feature channel according to the determined importance; and
encoding the feature channel into the bitstream according to the selected one or more encoding parameters,
wherein the determined importance differs for at least two feature channels among the two or more feature channels.

16. A method for decoding two or more feature channels of a neural network from a bitstream, wherein the method is applied to a decoding apparatus and comprises:
for each feature channel,
determining one or more encoding parameters based on the bitstream; and
decoding from the bitstream the feature channel based on the determined one or more encoding parameters,
wherein the encoding parameters differs for at least two among the two or more feature channels.

17. A non-transitory computer-readable medium storing a program, including instructions which upon execution by one or more processors cause the one or more processors to perform the method according to claim 15.

18. The method according to claim 15, further comprising:
generating the two or more feature channels, including processing an input picture with one or more layers of the neural network.

19. The method according to claim 15, wherein the one or more encoding parameters include any of coding unit size, prediction unit size, bit depth, and quantization step.

20. The method according to claim 15, wherein the two or more feature channels are for a single-task of the neural network, and
wherein the method further comprises determining the importance for the single task being accuracy of the neural network.
